(19) United States
(12) Patent Application Publication
(10) Pub. No.: US 2022/0265502 A1
(43) Pub. Date: Aug. 25, 2022

(54) SYSTEMS AND METHODS OF PORTABLE THERAPEUTICS OF EYE DISORDERS

(71) Applicant: Georgia Tech Research Corporation, Atlanta, GA (US)

(72) Inventors: Woon-Hong Yeo, Atlanta, GA (US); Saswat Mishra, Atlanta, GA (US)

(21) Appl. No.: 17/662,778

(22) Filed: May 10, 2022

Related U.S. Application Data
(63) Continuation of application No. 17/515,177, filed on Oct. 29, 2021.
(60) Provisional application No. 63/107,956, filed on Oct. 30, 2020.

(51) Int. Cl. A61H 5/00

(52) U.S. Cl. CPC A61H 5/005; A61H 2230/085; A61H 2201/1607; A61H 2201/165

(57) ABSTRACT

A fully wearable, wireless soft electronic system that offers a portable, highly sensitive tracking of eye movements (vergence) via the combination of skin-conformal sensors and a virtual reality system. Advancement of material processing and printing technologies based on aerosol jet printing enables reliable manufacturing of skin-like sensors, while the flexible hybrid circuit based on elastomer and chip integration allows comfortable integration with a user's head. Analytical and computational study of a data classification algorithm provides a highly accurate tool for real-time detection and classification of ocular motions. In vivo demonstration with 14 human subjects captures the potential of the wearable electronics as a portable therapy system, whose minimized form factor facilitates seamless interplay with traditional wearable hardware.

### CROSS-REFERENCE TO RELATED APPLICATIONS

This application is a continuation of U.S. patent application Ser. No. 17/515,177 filed 29 Oct. 2021, which claims benefit, under 35 USC § 119(e), of U.S. Provisional Application Ser. No. 63/107,956 filed 30 Oct. 2020. The entire contents and substance of the above applications are hereby incorporated by reference in their entireties.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The present invention relates generally to ocular therapeutics, and more particularly to a synergistic combination of soft, wireless wearable electronics and virtual reality provides a new avenue for portable therapeutics of eye disorders.

### 2. Description of Related Art

Ocular disorders are affecting the population at increasing rates in the smartphone era as more people utilize electronic devices at close ranges for prolonged periods. This problem is of particular concern among younger users as they are exposed to an excessive use of smart devices at early age.

One such ocular disease is convergence insufficiency (CI), which in the United States impacts from 1%-6% of children under the age of 19, adults, and from 40%-46% of military personnel with mild traumatic brain injury. Similar to CI, strabismus, an eye disorder commonly known as “crossed-eye”, affects approximately 4% of children and adults in the United States.

People with CI and strabismus exhibit debilitating symptoms including headaches, blurred vision, fatigue, and attention loss. These symptoms cost as much as USD1.2 billion in lost productivity resultant from computer-related visual complaints.

There are numerous causes for these ocular diseases ranging from sports-related concussions to genetic disorders, because even the simple movement of the eyes is a manifestation of a collaborative work among the brain, optic nerves, ocular muscles, and the eye itself. However, not only are the causes for most pediatric cases unknown, precise surgical or genetic approaches to address only the diseased tissues are absent, often leaving only clinical options to treatment plans based on ocular therapies.

Therapeutic techniques available for CI include office-based visual therapy (OBVT). Typical convergence orthoptics requires the patient to visit an optometrist's office for one hour every week for 12 weeks of procedural therapy targeting two ocular feedback methods—vergence and accommodation. These two therapeutic methods used in conjunction allow the human eyes to converge on both near point and far point objects.

Although OBVT with pencil pushups for home-based training has shown success rates as high as 73%, such home-based vision therapy often results in diminishing success rates declining to just 33% over time. Thus, alternative methods continue to be sought that can reduce outpatient visits by providing a reliable and effective home-based visual therapy.

One possible alternative method for home use includes virtual reality (VR) therapy systems. As an example, with a VR system running on a smartphone, “virtual therapies” can be created that can be used nearly anywhere, nearly anytime. By integrating a motion vergence system, the user can perform therapy without clinical supervision.

Alternative stereo displays are common for vision therapy, but a VR headset maintains binocular vision while disabling head motions for eye vergence precision. Currently, the most common technique of measuring vergence motions are video-oculography (VOG) and electrooculography (EOG). VOG uses a high-speed camera that is either stationary or attached to a pair of goggles with a camera oriented towards the eye, while EOG techniques utilize a set of Ag/AgCl electrodes mounted on the skin to non-invasively record eye potentials.

VOG has received research attention in the diagnosis of Autism, Parkinson's disease, and multiple system atrophy. A few studies demonstrate the capability of using VOG for CI assessments in vergence rehabilitation and the testing of reading capabilities of children. Unfortunately, due to the bulk of the hardware components necessary conventional VOG remains limited to home-based applications that necessitate the user to visit an optometrist's office equipped with a VOG system.

Recent advancements in device packaging and image processing techniques open the possibility of incorporating eye tracking capabilities within a VR headset by integrating infrared cameras near the lens of the headset. While embedding the eye tracking functionality in a VR headset may at first glance appear simple if not convenient, there are significant disadvantages to this approach.

First, the accuracy of an image-based eye tracking system relies heavily on the ability to capture clear pupil and eye images of the user. Thus, wide physiological variabilities such as covering of the pupil by eyelashes and eyelids can reduce successful detection of the pupil. For example, one study reported that only 37.5% of participants were able to provide eye tracking data.

Second, even state-of-the-art eye tracking algorithms exhibit variable performances that depends on different types of eye image libraries, unsurprisingly having eye detection rates as low as 0.6.

Third, integration of eye tracking components with VR hardware requires disruptive modification processes, thus inevitably increasing system cost and ultimately discouraging the dissemination of the technology. Furthermore, hardware integration necessitates calibration whenever the headset shifts preventing the ability to monitor the eyes without the use of the VR headset.

Fourth, while near-infrared (NIR) is classified as nonionizing, unknown biological effects other than corneal/retinal burns remain uninvestigated for prolonged, repeated, near-distance, and directed ocular NIR exposure.

Since EOG is a measurement of naturally changing ocular potential, placement of electrodes around the eyes leads to a highly sensitive detection method of eye movements (vergence) while obviating limits of VOG regarding physiological variabilities, image processing algorithms, hardware modification, and negative biological effects, while potentially enabling a low-cost and portable eye monitoring solution. Feasibility of an EOG-based detection of eye vergence has been shown, but lacks classification accuracy of multi-degree motions of eyes. In addition, the typical sensor package that uses conductive gels, adhesives, and metal conductors, are uncomfortable when mounted on sensitive tissues surrounding eyes and are too bulky to conform to the nose.

The use of EOG for game control in a VR environment has been demonstrated, but again the use of bulky hardware, cables, and electrodes limits portability necessary for a successful therapeutic system. Another study implemented an EOG-controlled VR environment via a customized headset and LED wall displays; however, the sophisticated setup rendered a practical solution nearly impossible as either a portable or affordable therapeutic tool.

These conventional systems rely on the detection of blinking and limited eye movement, and therefore lack the critical capability to detect multi-degree vergence, which is essential for diagnosis and therapy for eye disorders. Overall, not only are the conventional EOG settings highly limited for seamless integration with a VR system, but existing VR-combined EOG solutions lack practicality for home-based ocular therapeutics.

Thus, a need yet exists for successful home-based, portable therapeutics for the treatment of eye disorders. It is to such a synergistic combination of soft, wireless wearable electronics and virtual reality that the present invention is primarily directed.

### BRIEF SUMMARY OF THE INVENTION

In an exemplary embodiment of the present invention, a portable system comprises a wearable ocular device configured to be worn by a wearer and skin-conformal electronics.

The skin-conformal electronics can comprise at least one skin-like electrode that is configured to make conformal proximal contact with the nose of the wearer. The skin-conformal electronics can further comprise at least one flexible electronic circuit that is configured to make conformal proximal contact with the back of the neck of the wearer.

Each skin-like electrode can comprise a stretchable aerosol jet printed electrode.

The system can further comprise a processing system for running a therapy environment that simulates continuous movements of multiple objects in three varying depths of near, intermediate, and distance via the wearable ocular device.

The three varying depths can correspond to 1°, 2°, and 3° of eye motions.

The system can further comprise an audio system configured to guide the wearer through the therapy environment.

In an exemplary embodiment of the present invention, a portable system comprises a wearable ocular device comprising a virtual reality (VR) headset configured to be worn by a wearer, skin-conformal electronics comprising a first skin-like stretchable aerosol jet printed biopotential electrode configured for fit under the VR headset and high-fidelity detection of slight eye movements via conformal lamination on contoured areas around the eyes and nasal region of the wearer, and a second wireless circuit configured for lamination on the back of the neck of the wearer, and a processing system configured to provide accurate, real-time detection and classification of multi-degree eye vergence in a VR environment toward portable therapeutics of eye disorders.

The portable system can be an electrooculography (EOG)-based detection system of eye vergence with at least a 90% classification accuracy of multi-degree motions of eyes of the wearer.

The processing system can include a mobile application configured to present a visual therapy program for eye convergence and divergence motions.

The processing system can further include a MATLAB program configured to train and validate precise eye vergence motions for classification.

The classification can comprise an ensemble classifier based off subspace discriminant methods.

The classification can comprise a random forest classification algorithm that yields the at least a 90% classification accuracy.

In another exemplary embodiment of the present invention, an “all-in-one” wearable periocular wearable electronic platform is presented that includes soft, skin-like sensors and wireless flexible electronics. The soft electronic system offers accurate, real-time detection and classification of multi-degree eye vergence in a VR environment for a reliable portable therapeutic for eye disorders. For electrode fabrication, aerosol jet printing (AJP), an emerging direct printing technique, is employed to leverage the potential for scalable manufacturing that bypasses costly microfabrication processes.

The present invention includes the innovative implementation of AJP for fabrication of highly stretchable, skin-like, biopotential electrodes, made possible through a comprehensive set of testing results encompassing process optimizations, materials analyses, performance simulations and experimental validations. Due to the exceptionally thin form factor, printed electrodes can conform seamlessly to the contoured surface of the nose and surrounding eyes and fit comfortably under a VR headset.

An open-mesh electrode structure, designed by computational modeling, provides a highly flexible (180° with a 1.5 mm radius) and stretchable (up to 100% in biaxial strain) characteristic verified by cyclic bending and loading tests. A highly flexible and stretchable circuit, encapsulated in an adhesive elastomer, can be attached to the back of the user's neck without the necessity of adhesives or tapes—providing a portable, wireless, real-time recording of eye vergence via Bluetooth radio.

When worn by a user, the present EOG system enables accurate detection of eye movement while fully preserving the user's facial regions for comfortable VR application. An eye vergence study is herein presented that uses wearable soft electronics combined with a VR environment to classify vergence for portable therapeutics of eye disorders. In vivo demonstration of the periocular wearable electronics with multiple human subjects sets a standard protocol for utilizing EOG quantification with VR and physical apparatus, being useful for clinical studies with eye disorder patients.

The present invention further includes providing doctors with a quantitative method of analyzing home-based vision therapy for strabismus and convergence insufficiency issues. The skin-electrodes are stretchable and flexible enough to compress under a VR headset. The VR display shows the therapy program to the patient that is shown for near position, for intermediate position, and for the distance position.

The device and skin-electrodes are fabricated with a photolithography and an AJP process. Preferably, the relevant components are made of thin-film materials which allows it to fit under the VR headset and conform to the skin. The device can fit around most contoured surfaces.

The present system can further include a customized application to present the visual therapy program. Several types of data collection systems can be used, including a matrix laboratory like MATLAB, graphical user interface (GUI). The GUI has the functionality to record, store, and index data from the patient and then apply cross validation methods or real-time classification. A second method records and communicates data from a separate smartphone with the present device. The first option handles commercially-available data acquisition systems compatible with MATLAB, while the second option allows communication to the custom device.

The interface evokes an auditory command that results in sequential high resolution vergence motions for the patient. The MATLAB program is used to train and validate precise eye vergence motions for classification. A real-time algorithm can be utilized with a thresholding method, but otherwise cross validation can be applied. The classification system uses an ensemble classifier based off of subspace discriminant methods, also referred to as random forests. This classification method yields>90% accuracy for the best eye vergence test subjects.

The therapeutic programs were taken from the convergence insufficiency treatment trial methodology. Two programs, Brock String and Eccentric Circle, were selected based off of implementation feasibility. Analytics also suggests improvement in eye vergence with successive training with the present VR headset program.

Conventional discourse indicates limitations for multiple methods of recording vergence motions, including that electrooculogram limitations prevent its ability to record and classify eye vergence motions. But the present invention indicates otherwise, via the use of soft materials and skin-electronics. Bulky devices with external telemetry devices that may attach to the waist that increase motion artifacts and baseline drifts are indeed problematic. The present design uses dry electrodes with no issue with long term use (˜8 hours), unlike gel electrodes which dry out.

Conventional devices use either videooculography or scleral coils; the former is bulky and typically immobile while the latter is an implant. Neither make good candidates under a VR headset with therapeutic programs.

The present invention is a system that can be implemented in ocular therapeutic techniques. An integrated system allows for quantitative analysis of eye vergence motions as well as gaze tracking. The eye vergence component is explored and is conclusive in assisting patients with strabismus issues or convergence insufficiency problems. The therapeutic programs are loaded on a Samsung gear VR, which has the potential to be expanded to many ocular therapeutic techniques. A doctor can prescribe the device along with the Samsung gear VR to a patient to conduct home-based vision therapy seven days a week.

Additionally, a doctor can wirelessly receive the eye vergence signals with the classification results from the present machine learning classifier. These results can assist the doctor in discriminating between healthy and unhealthy patients as well as track progress over the period of the convergence insufficiency treatment procedures (12 weeks).

Conventional videooculography recordings uses an immobile setup, with a headrest and multiple stereographic monitors that display the therapy program. There are other physical therapeutic methods that can be prescribed, but there is a lack of a monitoring system. Multiple physical objects need to be prescribed to a patient for home-based therapy besides the conventional pencil pushups. Since the home-based methods are ineffective and prescription therapeutic procedures can be cumbersome, the present virtual reality headset packages the therapy programs for ease of use for patients.

These and other objects, features, and advantages of the present invention will become more apparent upon reading the following specification in conjunction with the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying Figures, which are incorporated in and constitute a part of this specification, illustrate several aspects described below.

FIGS. 1A-1K are an overview of an exemplary embodiment of the present invention as a soft, wireless periocular electronic system that integrates a VR environment for home-based therapeutics of eye disorders.

FIGS. 2A-2E present an apparatus for testing eye vergence motions.

FIGS. 3A-3H illustrate circuit components, bending, and powering of the present flexible device according to an exemplary embodiment.

FIGS. 4A-4L illustrate an AJP parametric study supplemented by the characterization of deposited NP ink.

FIGS. 5A-5S illustrate the design and characterization of the AgNP electrodes.

FIGS. 6A-6I illustrate the stretching/bending properties of the skin-like electrodes fabricated by AJP.

FIGS. 7A-7F show a comparison between Ag/AgCl gel electrodes and aerosol jet—printed skin-like electrodes.

FIGS. 8A-8G are a study of ocular vergence and classification accuracy based on sensor positions.

FIGS. 9A-9D provide an electrode assessment for subjects 11 to 13, showing confusion matrices for subject 11 through 13 using the virtual reality training platform.

FIGS. 10A-10D are graphs related to the sensitivity of the periocular wearable electronics.

FIGS. 11A-11H illustrate the optimization of vergence analysis via signal processing and feature extraction.

FIGS. 12A-12F are a comparison of ocular classification accuracy between VR and a physical apparatus.

FIGS. 13A-13V illustrate performance differences between the periocular wearable electronics and the physical apparatus.

FIGS. 14A-14L are a comparison of average amplitudes from vergence training and a summary of classification accuracies.

FIGS. 15A-15E illustrates the present VR-enabled vergence therapeutic system according to an exemplary embodiment.

FIGS. 16A-16O illustrate the fabrication and assembly processes for the flexible device and the skin-like electrodes.

### DETAIL DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

As discussed, ocular disorders are currently affecting the developed world, causing loss of productivity in adults and children. While the cause of such disorders is not clear, neurological issues are often considered as the biggest possibility. Treatment of strabismus and vergence requires an invasive surgery or clinic-based vision therapy that has been used for decades due to the lack of alternatives such as portable therapeutic tools. Recent advancement in electronic packaging and image processing techniques have opened the possibility for optics-based portable eye tracking approaches, but several technical and safety hurdles limit the implementation of the technology in wearable applications.

The present invention is a fully wearable, wireless soft electronic system that offers a portable, highly sensitive tracking of eye movements (vergence) via the combination of skin-conformal sensors and a virtual reality system. Advancement of material processing and printing technologies based on AJP enables reliable manufacturing of skin-like sensors, while a flexible electronic circuit is prepared by the integration of chip components onto a soft elastomeric membrane.

Analytical and computational study of a data classification algorithm provides a highly accurate tool for real-time detection and classification of ocular motions. In vivo demonstration with human subjects captures the potential of the wearable electronics as a portable therapy system, which can be easily synchronized with a virtual reality headset.

Recording eye vergence via EOG has been deemed difficult by ocular experts because of the signal sensitivity, warranted by the lower conformality and motion artifacts of conventional gel electrodes in comparison to skin-like, soft electrodes. Additionally, a pragmatic experimental setup that can invoke a precise eye vergence response is lacking.

The present invention incorporates nanostructured membrane circuits and skin-like electrodes which are stretchable and flexible enough to compress under a VR headset as well as conform to the contour of the human nose. The stretchable hybrid electronics are made of ultrathin, biocompatible materials which enable ergonomic, continuous sensing of electrooculograms. A VR headset with a customized android application presents the visual therapy program for eye convergence and divergence motions.

An external MATLAB program is used to train and validate precise eye vergence motions for classification. The classification system uses an ensemble classifier based off subspace discriminant methods, also referred to as random forests. This classification method yields higher than 90% accuracy for the best eye vergence test subjects.

Analytics also suggests improvement in eye vergence with successive training with the VR headset program and the sensors. Further analysis of a patient indicates the sensors can invoke strabismus motions that are recordable and classifiable. This invention improves current home-based vision therapy methods by allow optometrists to prescribe patients an alternative to archaic pencil pushups.

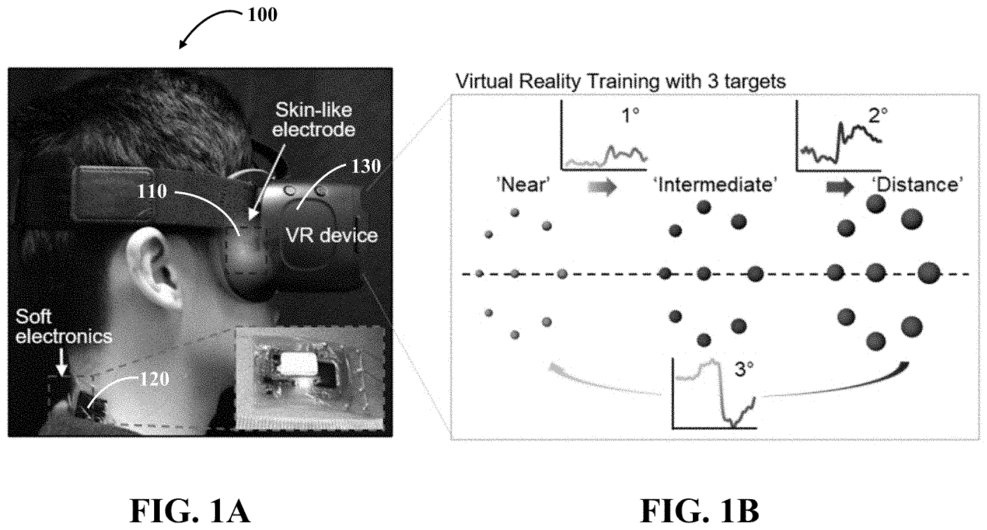

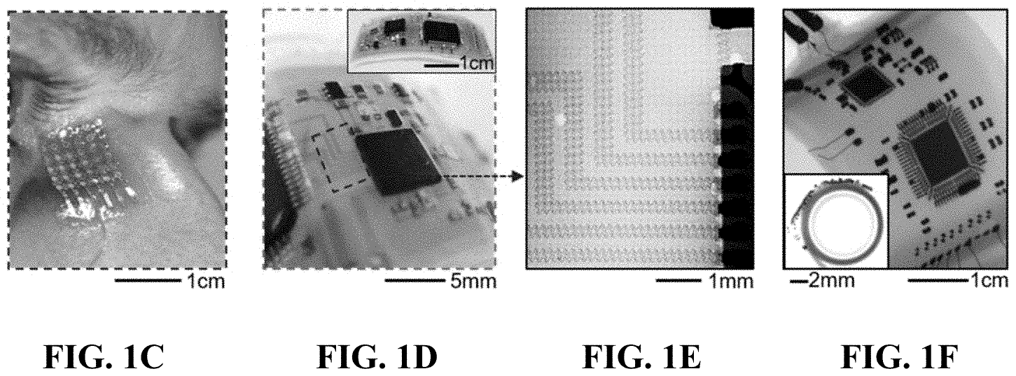

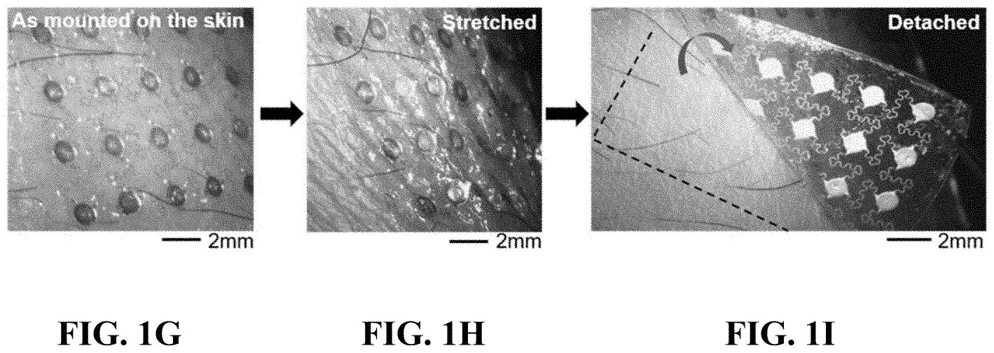

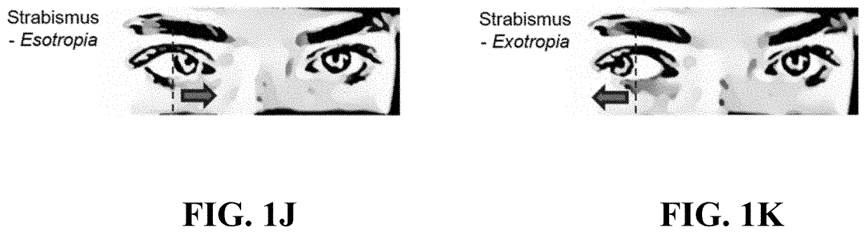

As shown in FIGS. 1A-1K, the present invention comprises a VR-integrated eye therapy system and wearable ocular electronics. The present invention is a soft, wireless periocular electronic system that integrates a virtual reality (VR) environment for home-based therapeutics of eye disorders. FIG. 1A illustrates a portable, wearable system 100 for vergence detection via skin-like electrodes 110, a soft circuit 120 and relevant therapeutics with integrated with a VR device 130. The inset of FIG. 1A is a zoomed inset details of a magnetically integrated battery power source.

FIG. 1B presents an exemplary VR therapy environment that simulates continuous movements of multiple objects in three varying depths of near, intermediate, and distance (corresponding to 1°, 2°, and 3°) of eye motions.

FIG. 1C is a zoomed-in photo illustrating a skin-like electrode of the present invention that makes a conformal contact to the nose. FIG. 1D illustrates an exemplary embodiment of a highly flexible, soft electronic circuit mounted on the back of the neck. FIGS. 1E, 1F are X-ray images of magnified mesh interconnects (FIG. 1E) and circuit flexion with a small bending radius (FIG. 1F).

FIGS. 1G, 1H, 1I are photos of an ultrathin, mesh structured electrode, mounted near eyebrow. FIGS. 1J, 1K illustrate two types of eye misalignment due to a disorder: esotropia (inward eye turning) (FIG. 1J) and exotropia (outward deviation) (FIG. 1K), which is detected by the present wireless ocular wearable electronics.

As shown, the present portable therapeutic system incorporates a set of stretchable aerosol jet printed electrodes 110, soft wireless electronics 120 on the back of the user's neck, and a VR device 130. The portable system offers a highly sensitive, automatic detection of eye vergence via a data classification algorithm.

As shown in FIG. 1B, the VR therapy environment simulates continuous movements of multiple objects in three varying depths of near, intermediate, and distance (corresponding to 1°, 2°, and 3°) of eye motions, which enables portable ocular therapeutics without the use of a physical apparatus. Audio feedback in the system interface guides the user through the motions for high-fidelity, continuous signal acquisition towards training and testing purposes. Engineered nanomaterials were used to design an ultrathin, skin-like sensor for high-fidelity detection of slight eye movements via conformal lamination on the contoured areas around the eyes and nasal region (FIG. 1C).

A scalable additive manufacturing method using AJP was used to fabricate the skin-wearable sensor, which was connected to a fully portable, miniaturized wireless circuit that is ultralight and highly flexible for gentle lamination on the back of the neck. For optimization of sensor location and signal characterization, a commercial data acquisition system (BioRadio, Great Lakes NeuroTechnologies) was initially utilized.

TABLE 1 illustrates feature comparison between the BioRadio and present periocular wearable electronics. Integration of advanced chip components allow the periocular wearable electronics to be equipped with comparable electronic performances to BioRadio while achieving the extremely light weight.

TABLE 1

| | | Periocular Wearable |
|---|---|---|
| | BioRadio | Electronics |
| Wireless Connection | Bluetooth Classic + LE | Bluetooth LE (4.2) |
| Data Rate | 190 kbps | 120 kbps |
| Differential Channels | 4 | Up to 8 |
| Sampling Resolution | Up to 24-bit | 24-bit |
| Common Mode | −100 dB | −110 dB |
| Rejection | | |
| Input Impedance | 500 MΩ | 1000 MΩ |
| Capacity | 8 GB | No Storage |
| Sample Rate | 250-16 kHz | 250-16 kHz |
| Battery Life | ~9 hours (1320 mAh) | ~1 hour (105 mAh) |
| Battery Type | Lithium-Ion Polymer | Lithium-Ion Polymer |
| Device Weight | 115 G | 5.5 G (3.3 G |
| | | Without Battery) |

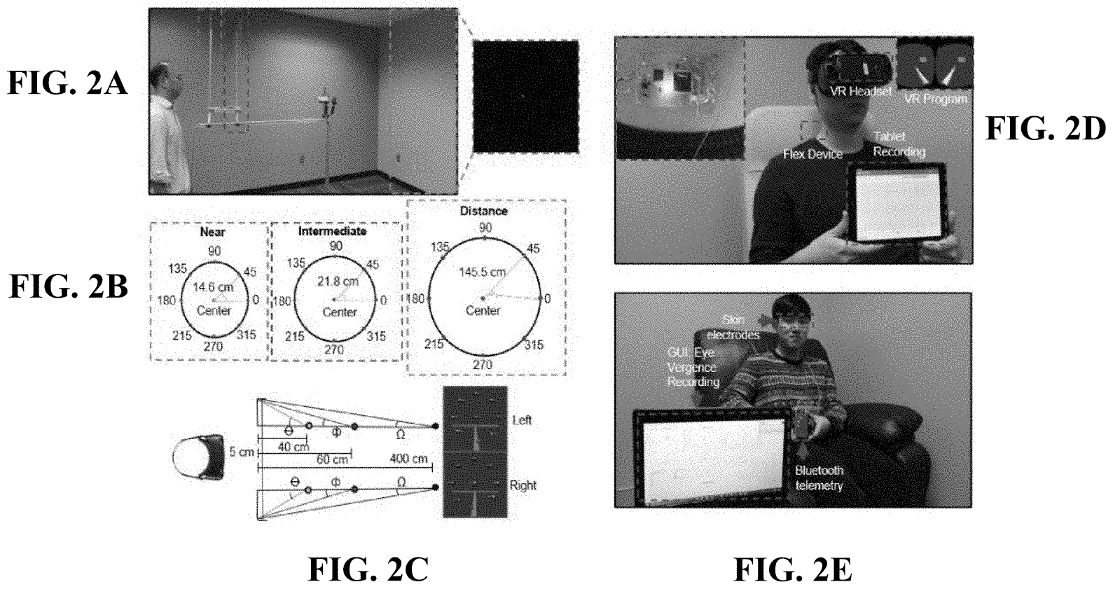

FIGS. 2A-2E illustrate two apparatus for testing eye vergence motions. FIG. 2A is a photo of the setup of the physical apparatus. Dimensions of the apparatus for the physical setup include positions that approximate to 1°, 2°, and 3° of motion (FIG. 2B). The VR images are offset for each eye to simulate binocular vision in the real world (FIG. 2C). FIGS. 2D, 2E illustrate data collection methods for both the periocular wearable electronics and the BioRadio device. Flexible device data collection with an Android device (FIG. 2D) and conventional data acquisition with rigid Bluetooth device and MATLAB interface (FIG. 2E).

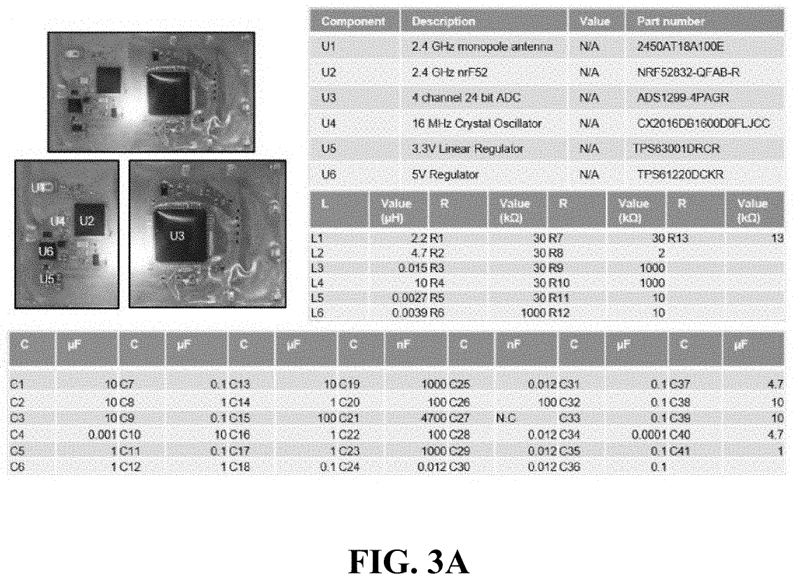

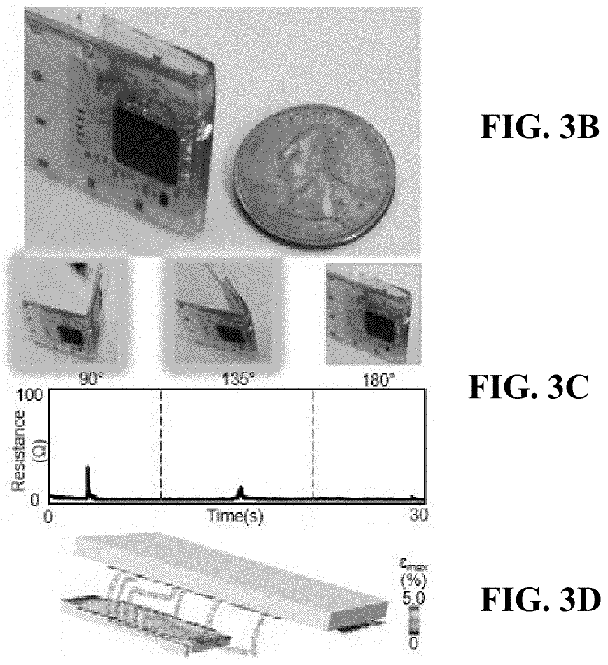

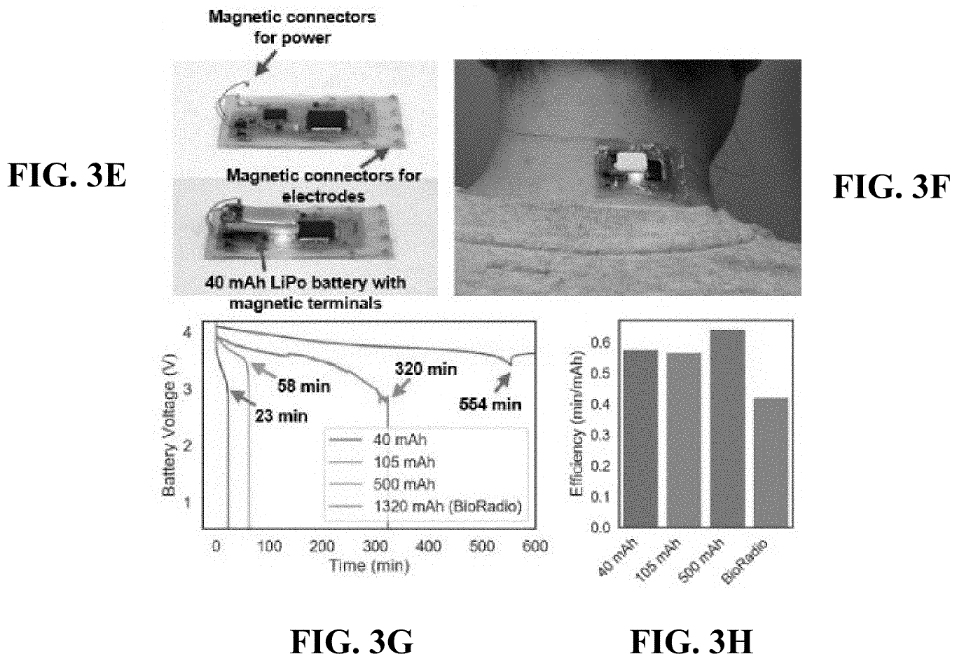

The systematic integration of lithography-based open-mesh interconnects on a polyimide (PI) film, the bonding of small chip components, and the encapsulation with an elastomeric membrane, each enable the benefits of the present soft and compliant electronic system. The flexible electronic circuit includes different modules that allow for wireless, high-throughput EOG detection. The antenna (FIG. 3A) can be a monopole ceramic antenna that is matched with a T-matching circuit to the impedance of the Bluetooth radio (nRF52, Nordic Semiconductor), which is serially connected to a 4-channel 24-bit analog-to-digital converter (ADS1299, Texas Instrument) for high resolution recording of EOG signals (FIG. 1D). A bias amplifier is configured for a closed loop gain of the signals. In the electronics, an array of 1 μm-thick and 18 μm-wide interconnects (FIG. 1E) ensures high mechanical flexibility by adsorbing applied strain to isolate it from chip components. Experiments of bending in FIG. 1F capture the deformable characteristics of the system, even with 180° bending at a small radius of curvature (1 mm). The measured resistance change is less than 1% at the area of bending in between the two largest chips, which means the unit continues to function.

FIGS. 3A-3H show circuit components, bending, and powering of the flexible device. FIG. 3A is a photograph of the flexible device details the locations for the chip components and the tables list the parts used in the design. FIG. 3B illustrates the is compared to the American quarter showing the size of the device (top). FIG. 3C show successive bending of the device from 90°-180° shows minor fluctuations in resistance and continuous operation of the device. FIG. 3D is an FEA simulation of device bending. FIG. 3E are photographs showing the integration of the small lithium-ion polymer battery with miniaturized magnetic terminals. Two wires with respective magnetic polarities enables the easy battery integration. As pointed by the arrow on the right, the same magnetic connectors are allocated for EOG signals. FIG. 3F shows the operation of the device on the back of the user's neck. ACF wires with magnetic terminals allow for reversible wire attachment. FIG. 3G is a graph of the battery voltage measurements of periocular wearable electronics and BioRadio. Arrows indicate data points when Bluetooth is disconnected. FIG. 3H is a graph of the efficiency for periocular wearable electronics with various battery capacities and BioRadio (1330 mAh) calculated by dividing the time of operation by battery.

The ultrathin, dry electrode (thickness: 67 μm including a backing elastomer) makes an intimate and conformal bonding to the skin (FIGS. 1G, 1H) without the use of gel and/or adhesive. The conformal lamination comes from the elastomer's extremely low modulus and high adhesion forces as well as the reduced bending stiffness of the electrode by incorporating the open-mesh and serpentine geometric patterns. The open-mesh, serpentine structure can even accommodate dynamic skin deformation and surface hairs near eyebrow for sensitive recording of EOG. The device can be powered by a small rechargeable lithium-ion polymer battery that is connected to the circuit via miniaturized magnetic terminals for easy battery integration. Photographs showing the details of battery integration and magnetic terminals are shown in FIGS. 2E-2H. The present ocular wearable electronic system, in conjunction with a data classification algorithm for eye vergence, aims to diagnose diseases like strabismus that is most commonly described by the direction of the eye misalignment (FIGS. 1J, 1K). With the integration of a VR program, the present portable system can serve as an effective therapeutic tool to find many applications in eye disorder therapy.

Conformal Contact Analysis for Aerosol Jet—Printed Electrodes

For conformal contact to occur, the magnitude of adhesion energy must be larger than the sum of the bending and elastic energy. Equation (1) describes this condition:

0<U_{bending}+Uₛₖᵢₙ+U_{adhesion} (1)

Then, defining each of these energy terms. Bending energy is defined as:

$${U}_{bending} = \frac{1}{{κ}_{rough}} {\int }_{0}^{λ} \frac{{EI}_{electrode} ( {w}^{″} )}{2} dx = \frac{{π}^{4} {{EI}_{electrode} ( h )}^{2}}{{λ}_{rough}^{4}} \qquad ( 2 )$$

The bending stiffness, EI_{electrode}, is calculated via:

EI_{electrode}=αEI_{PI/Ag}+(1−α)EI_{silicone} (3)

where α is the PI/Ag area fraction of the skin-like electrode. The bending stiffness is split into that for the silicone elastomer layer and the PI/Ag pattern:

$${EI}_{silicone} = {EI}_{silicone} {h}_{silicone}^{3} / 12 \qquad ( 4 )$$

$${EI}_{PI / Ag} = {\sum }_{i = 1}^{N} {E}_{i} {h}_{i} [ {( b - {\sum }_{j = 1}^{i} {h}_{j} )}^{2} + ( b - {\sum }_{j = 1}^{i} {h}_{j} ) {h}_{i} + \frac{1}{3} {h}_{i}^{2} ] \qquad ( 5 )$$

$$b = {\sum }_{i = 1}^{N} {E}_{i} {h}_{i} ( {\sum }_{j = 1}^{i} {h}_{j} - \frac{1}{2} {h}_{i} ) / {\sum }_{i = 1}^{N} {E}_{i} {h}_{i} \qquad ( 6 )$$

The skin surface is modeled with a sine wave as:

$$w ( x ) = \frac{h}{2} ( 1 + cos \frac{2 π x}{{λ}_{rough}} ) \qquad ( 7 )$$

While the displacement of the electrode is defined as:

$${u}_{z} ( x ) = y - w = \frac{{h}_{rough} - h}{2} ( 1 + cos \frac{2 π x}{{λ}_{rough}} ) \qquad ( 8 )$$

We assume the following dimensions to represent the properties of human skin:
h_{rough}=55 μm;
λ_{rough}=140 μm; and
Eₛₖᵢₙ=130 kPa

where h_{rough} is roughness amplitude, λ_{rough} is wavelength, and Eₛₖᵢₙ is the modulus of skin.

The elastic energy of the skin, due to normal stress, is defined as:

$${σ}_{z} = \frac{π {E}_{skin} ( {h}_{rough} - h )}{2 {λ}_{rough}} cos \frac{2 π x}{{λ}_{rough}} \qquad ( 9 )$$

$${U}_{skin} = \frac{1}{{λ}_{rough}} {\int }_{0}^{{λ}_{rough}} \frac{{u}_{z} {u}_{z}}{2} dx = \frac{π {{E}_{skin} ( {h}_{rough} - h )}^{2}}{16 {λ}_{rough}} \qquad ( 10 )$$

The interfacial adhesion energy is calculated as:

$${U}_{adhesion} = - γ {\int }_{0}^{λ} \sqrt{1 + ( {w}^{′} )} dx \approx - γ \frac{{π}^{2} {h}^{2}}{4 {λ}_{rough}^{2}} \qquad ( 11 )$$

$$for the case {λ}_{rough} ∼ 7 {h}_{rough}$$

The work of adhesion value is dominated by the elastomer, and the electrode's total value is:

γ=(1−α)γ_{silicone/skin} (12)

Minimizing the total energy to express maximum deflection of the electrode results in terms of h:

$$h = \frac{{E}_{skin} {h}_{rough}}{\frac{16 {π}^{3} {EI}_{electrode}}{{λ}_{rough}^{2}} + {E}_{skin}} \qquad ( 13 )$$

Then, substituting into Equation (1):

U_{bending}+Uₛₖᵢₙ+U_{adhesion}=−0.150J (14)

Thus, conformal contact occurs between the electrode and skin.

Parameters used in this calculation include:
E_{silicone}=7.85 kPa
γ_{silicone/skin}=0.89;
E_{PI}=2.5 GPa;
E_{Ag}=69 GPa;
h_{silicone}=65 μm;
h_{PI}=1 μm;
h_{Ag}=1 μm; and
α=33.47%.

### Characterization and Fabrication of Wearable Skin-Like Electrodes Via AJP

A highly sensitive detection of EOG signals requires a low skin-electrode contact impedance and minimized motion artifacts. Even though a conventional electrode offers a low-contact impedance due to the electrolyte gel, the combination of the sensor rigidity, size, and associated adhesive limits an application onto the sensitive and highly contoured regions of the nose and eye areas.

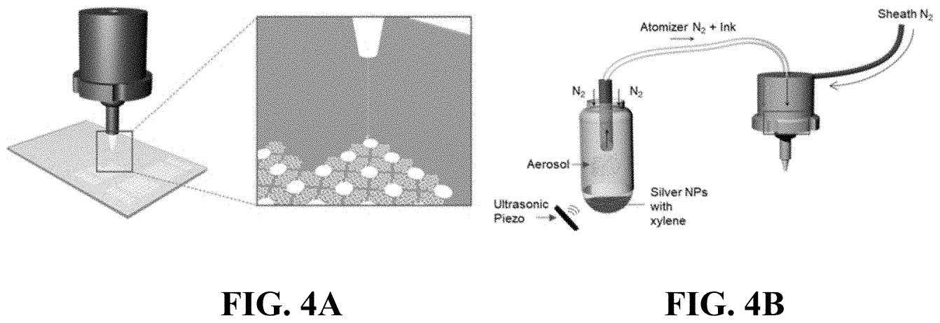

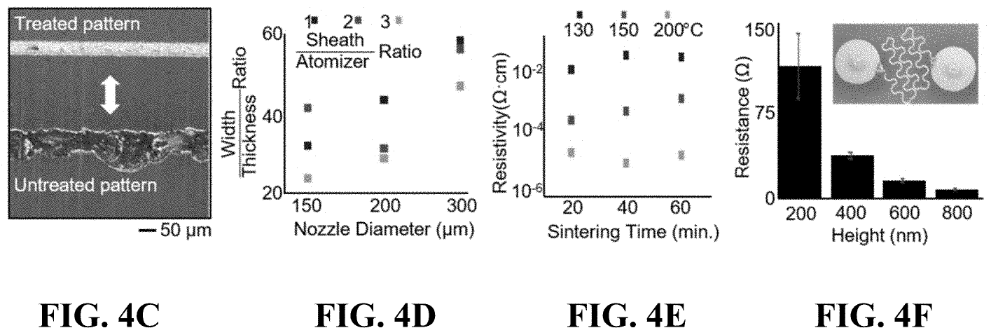

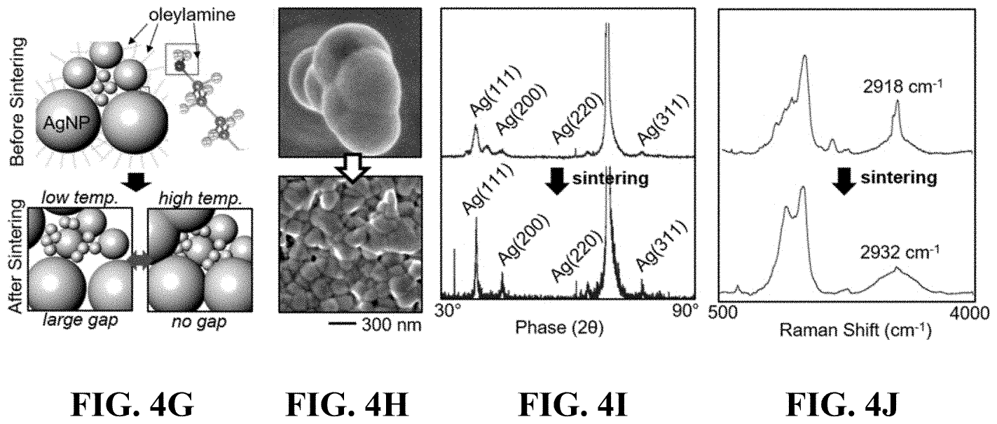

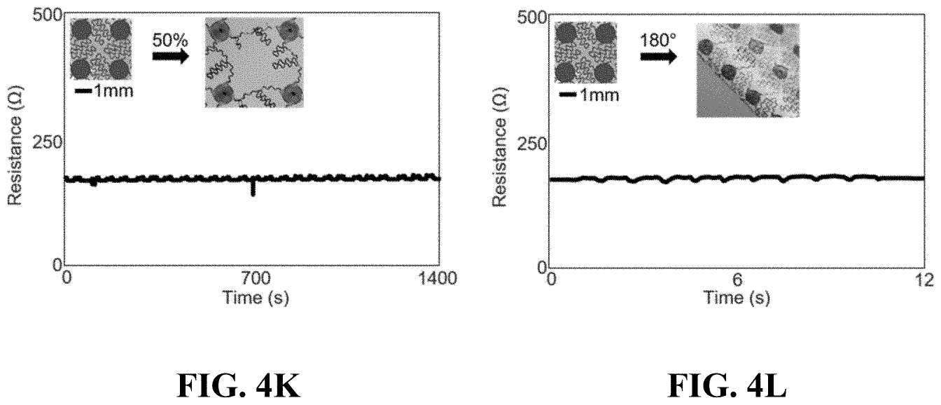

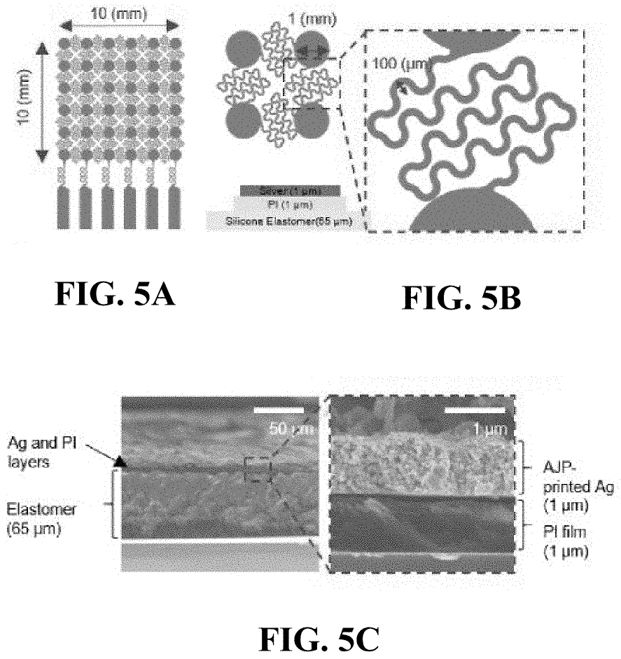

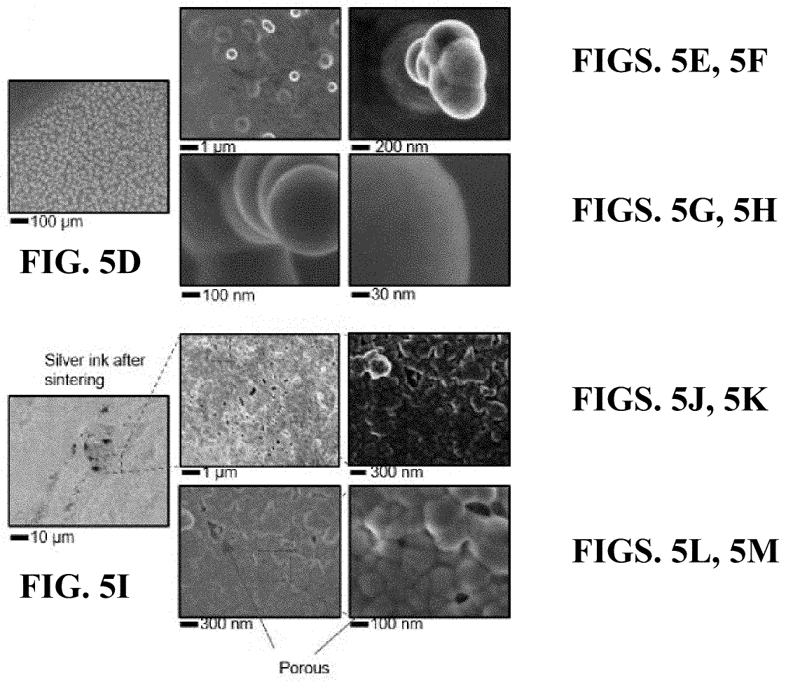

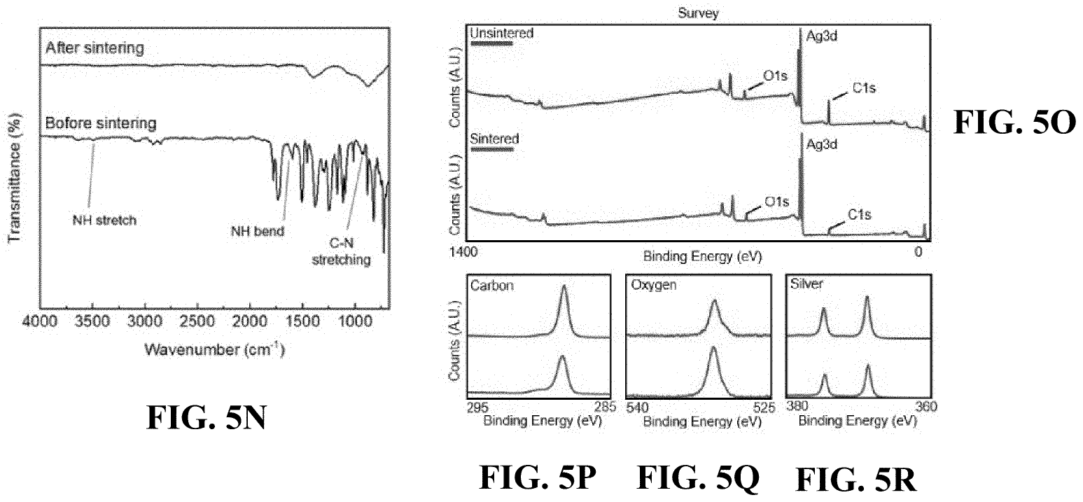

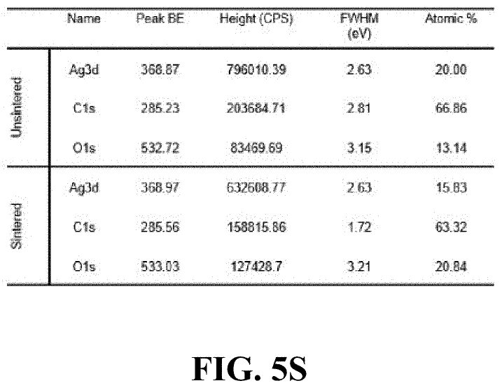

As shown in FIGS. 4A-4L, an innovative additive manufacturing technique was developed to design an ultrathin, highly stretchable, comfortable dry electrode for EOG detection. FIGS. 5A-5S illustrate the design and characterization of the AgNP electrodes.

FIGS. 4A-4L illustrates an AJP parametric study supplemented by the characterization of deposited NP ink. FIG. 4A shows AJP out of deposition head with a close-up of deposition. FIG. 4B shows atomization begins in the ultrasonic vial and a carrier gas (N₂) flows the ink droplets through tubing, the diffuser, and the deposition head where a sheath gas focuses the particles into a narrow stream with a diameter of ˜5 In FIG. 4C, platen is heated to ensure evaporation of the solvents, but surface treatment with plasma cleaner enables clean lines (top). Otherwise, the traces tend to form into bubbles over a large area. FIG. 4D is a graph showing a high focusing ratio with low width/thickness ratio enables lower resistivity. FIG. 4E is a graph showing resistivity measurements from a four-point probe system determined for various sintering temperatures and time. FIG. 4F is a graph showing that ultimately, the resistance of the electrodes needs to be low, so a two-point probe measurement demonstrates the resistance across a fractal electrode in series.

FIG. 4G illustrates AgNPs capped with oleylamine fatty acid that prevents agglomeration end up breaking down after low- and high-temperature sintering. The grain size for small NPs increases at low temperatures, and then, that for bigger NPs increases at higher temperatures. FIG. 4H are SEM images that show the agglomeration and densification of the binder material after sintering. FIG. 4I is an X-ray diffraction analysis that shows larger crystallization peaks after sintering and the recrystallization of peaks along (111), (200), and (311) crystal planes. The large peak between (220) and (311) represents Si substrate. FIG. 4J is a Raman spectroscopy that demonstrates the loss of carbon and hydrogen peaks from the binder dissociation near wave number 2900 cm⁻¹. FIG. 4K shows cyclic stretching (50% strain) of the electrode, and FIG. 4L shows cyclic bending (up to 180°) of the electrode.

FIGS. 5A, 5B illustrates the skin-like electrode's dimensions and have an array of 1 mm diameter circles interconnected with fractal-shaped traces. The circular feature increases the overall contact area while the fractal-shaped interconnection enables stretching. The radius of each curve is 100 μm with a trace width ranging from 20 μm-60 μm depending on the type process used. FIG. 5C is a cross-sectional SEM images revealing the morphology and thickness of the layers comprising the skin-like electrode. The close-up image on the right shows the thin PI/Ag bilayer structure.

FIGS. 5D-5M are SEM images of AgNP ink after deposition and degassed (FIGS. 5D-5H) and after sintering (FIGS. 5I-5M). FIG. 5N is a graph showing FTIR transmittance spectra of aerosol jet printed pattern before and after sintering. Peaks present in the ‘before sintering’ sample are from (i) oleylamine, (ii) solvent (aromatic) in Ag ink, and (iii) PI. ‘After sintering’ curve contains only the general PI peaks and metallic Ag. FIGS. 5O-5S are the XPS characterization of AgNPs before sintering and after sintering. A survey of the AgNP ink solution indicates carbon, oxygen, and silver. The concentrations of oxygen and carbon change after sintering the sample.

As a potentially low-cost and scalable printing method, AJP allows a direct printing of an open-mesh structure onto a soft membrane (FIG. 4A) without the use of an expensive nano-microfabrication facility. For successful printing, a parametric study was conducted to understand the material properties of silver nanoparticles (UT Dots) along with the controlled deposition through various nozzles of the AJP (FIG. 4B; AJ200, Optomec). Prior to the electrode fabrication, printing lines were assessed for its wettability by qualitatively determining the surface energy on a PI substrate.

Plasma treatment along with platen heat was used to produce fine features (FIG. 4C). To find the optimal printed structure, a few key parameters were varied, including the ratio of line width and thickness for each nozzle diameter with different focusing ratios and sintering time with different temperatures (FIGS. 4D, 4E). In the focusing ratio (FIG. 4D), the sheath flow controls the material flow rate through the deposition head and the atomizer flow controls the material leaving the ultrasonic atomizer bath. The highest focusing ratio has the lowest width to thickness ratio, which ensures a smaller width for a higher thickness. This yields a lower resistance for finer traces which is necessary for the ideal sensor geometry (width of a trace: 40 μm and entire dimension: 1 cm² (FIG. 4A). A four-point probe system (S-402-A, Signatone) measures the resistivity of the printed ink sintered at different temperatures and time periods (FIG. 4E).

As expected, multi-layer printing of AgNPs provides lowered resistance (FIG. 4F). The good conductivity of printed traces was ensured by the sintering process at 200° C. (FIG. 4G). Images from scanning electron microscopy (SEM; FIG. 4H) reveal the AgNP agglomeration and densification, which is an indirect indication for the dissociation of oleylamine binder material that surrounds the NPs (FIGS. 5D-5M). In addition, X-ray diffraction shows various crystalline planes of AgNPs that become more evident after sintering due to the increasing grain sizes, demonstrated by the decrease in broadband characteristics of the peaks in FIG. 4I. This change in crystallinity is due to the decomposition of the oleylamine capping agent. In FIG. 4J, Raman spectroscopy shows a narrow peak at 2918 cm⁻¹ before sintering which is converted to a much broader peak centered at 2942 cm⁻¹ after sintering. This indicates a decrease of CH₂ bonds in the capping agent as well as small shift in the amine group (1400-1600 cm⁻¹).

An FTIR analysis further verifies the dissociation of the binder. The FTIR transmittance spectra for the printed electrodes before and after sintering indicate the disappearance of ‘NH stretch’, ‘NH bend’, and “C-N stretching’, which confirms the dissociation of oleylamine (FIG. 5N). Furthermore, surface characterization using X-ray photoelectron spectroscopy indicates a decrease in the full-width-half maximum of carbon and increase in oxygen, which resembles an overall percent of decrease in the elemental composition. These atomic percentage increases are due to the breakdown of the binder and the increase in oxidation of AgNPs (FIGS. 5O-5S).

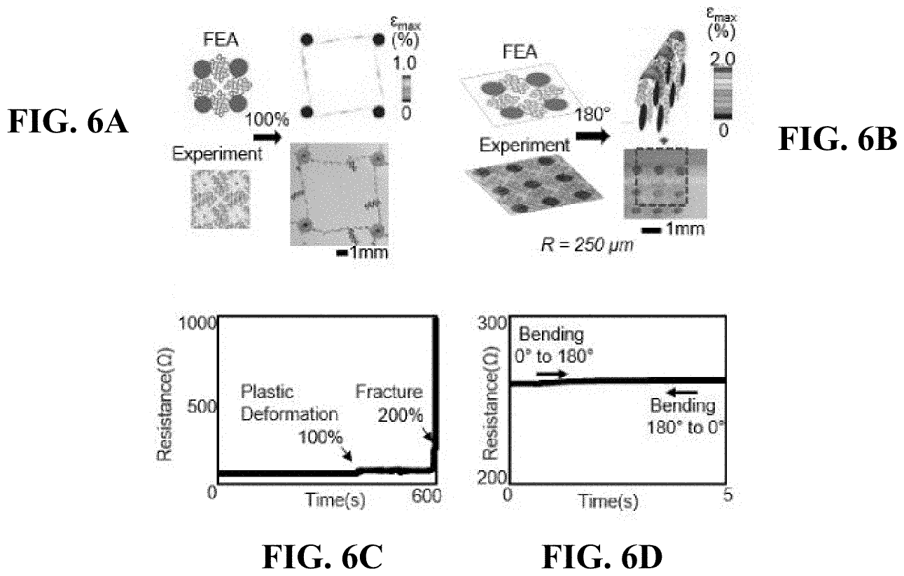

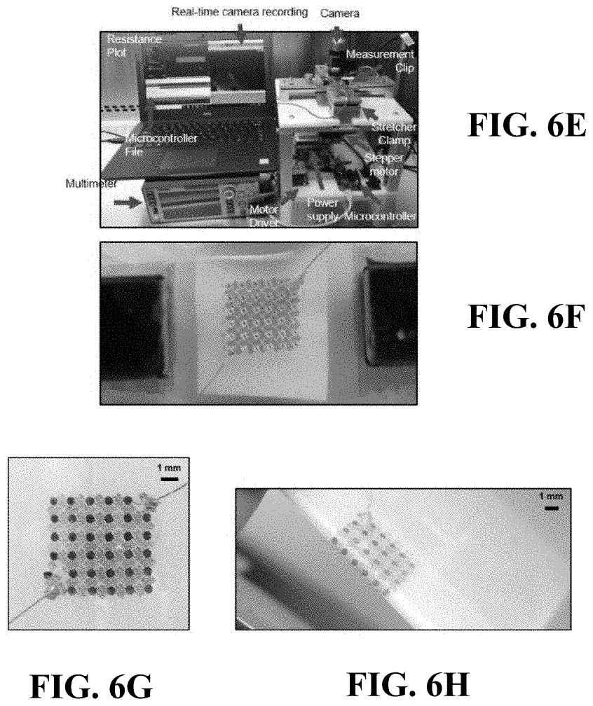

FIGS. 6A-6I illustrate the stretching/bending properties of the skin-like electrodes fabricated by AJP. FIG. 6A is an FEA simulation of open mesh sensor stretching and bending. The electrode is stretched up to 100% before there is a change in resistance. FIG. 6B shows the electrode is then bent 180° at a bending radius of 250 μm. FIG. 6C is a graph of the resistance of the electrode increases as the biaxial stretcher passes 100% stretchability up to 200% where the sensor fractures.

FIG. 6D is a graph of the loading and unloading of the sensor, which shows no resistance change therefore the device continues to function flawlessly. FIG. 6E shows computer vision for monitoring the skin-like electrode stretching with resistance measurements from the digital multimeter. FIG. 6F illustrates that the contact for the resistance measurements is made possible with copper wire and silver paste from end to end contact. FIG. 6G shows the skin-like electrode setup for bending test with 250 μm bending radius. FIG. 6H shows the electrode bent by 180°.

FIG. 6I shows the skin-like electrode direct writing process and post processing using reactive ion etching and reduction of silver nanoparticles. After atomization and deposition, a full electrode array is ready to be processed by dry etching. There are two options for dry etching, first option is to etch the PI after printing and second option is to deposit photoresist onto the silver patterns by alignment. A close up shows the deposition location and the beam diameter of 5 μm. After depositing all electrodes on the substrate, the sample can be treated in oxygen plasma to etch the PI. After etching, oxygen has impinged the silver and needs to be reduced or the photoresist stays intact, and the silver is protected while the PI is etched away. The final reduction step is conducted in a RIE with argon gas which removes most of the oxygen. The final electrode array comes out of the RIE bright white after removing photoresist or reducing.

The mesh design of an electrode provides a highly flexible and stretchable mechanics upon multi-modal strain, supported by the computational modeling. A set of experimental tests validates the mechanical stability of the sensor where the structure can be stretched up to 100% before a change in resistance is observed (FIGS. 6A-6D), cyclically stretched up to 50% without a damage (FIG. 4K), and bendable up to 180° with a very small radius of curvature (250 μm; FIG. 4L). Details of the mechanical stretching and bending apparatus and processes are shown in FIGS. 6E-6H.

The printed electrode follows dry etching of PI and transfer onto an elastomeric membrane by dissolving a sacrificial layer, which prepares the sensor to be mounted on the skin (details of the processes appear in FIG. 6I). Finally, the performance of the printed skin-like electrodes was compared to that of conventional gel electrodes (MVAP-II Electrodes, MVAP Medical Supplies) by simultaneously applying the two types of electrodes on each side of a subject with an electrode configuration enabling the measurements of vertical eye movements.

Skin-electrode contact impedances are measured by plugging the pair of electrodes (positioned above and below each eye) to a test equipment (Checktrode Model 1089 MK III, UFI) and recording the measurement values at both the start and finish of the experimental session. One-hour period is chosen to represent the average duration of vergence therapeutic protocols.

At the start of the session, the average impedance values for the two types of electrodes show 7.6 kΩ and 8.4 kΩ for gel and skin-like electrodes, respectively. After one hour, the respective impedance values change to 1.2 kΩ and 6.3 kΩ, respectively, indicating the formation of excellent skin-to-electrode interfaces by both types of electrodes.

Next, the subject performs a simple vertical eye movement protocol by looking up and down to generate EOG signals for signal-to-noise ratio (SNR) comparison. The SNR analysis, which is carried out by finding the log ratio of root mean square (RMS) values for each EOG signal (up and down) and the baseline signal from ten trials, is also performed at the start and finish of the one hour session.

While the SNR results show comparable performances and no meaningful changes in the two types of electrodes over the one hour period, the skin-like electrodes maintained higher SNR values in all cases.

Lastly, the electrode's sensitivity to movement artifacts is quantified by requesting the user to walk on a treadmill with a speed of 3.2 mph for one minute. The RMS of the two data from each electrode type are quantified to be 2.36 μV and 2.45 μV for gel and skin-like electrodes, respectively, suggesting that, in terms of movement artifact, the use of skin-like electrodes do not offer realistic disadvantages to using the gel adhesive electrodes.

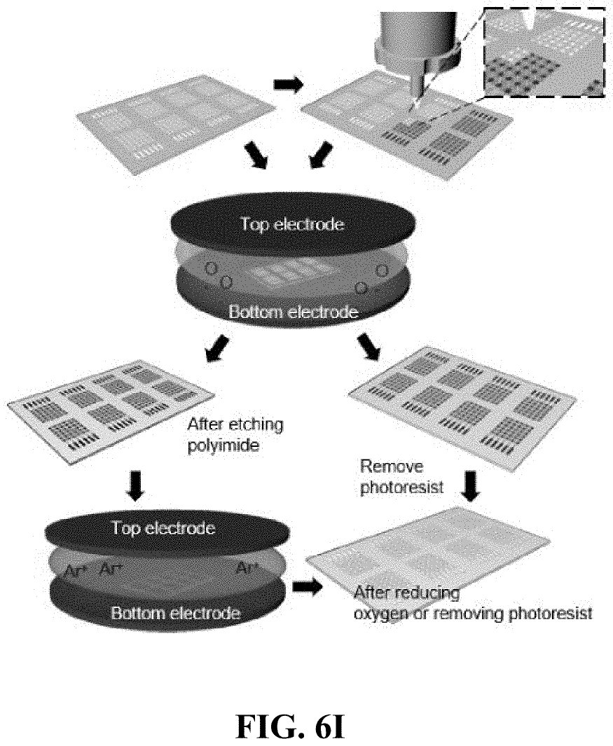

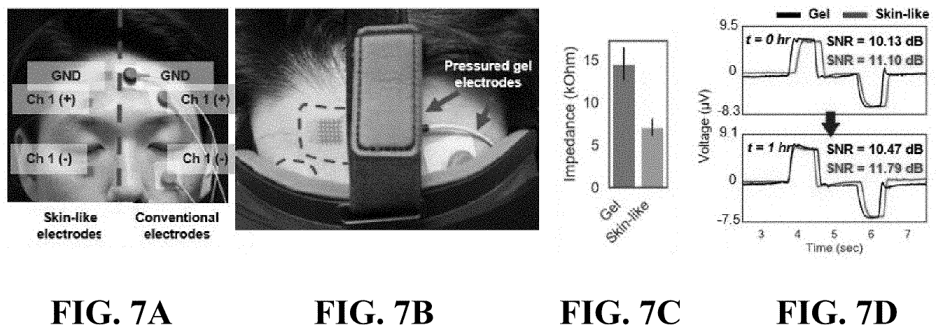

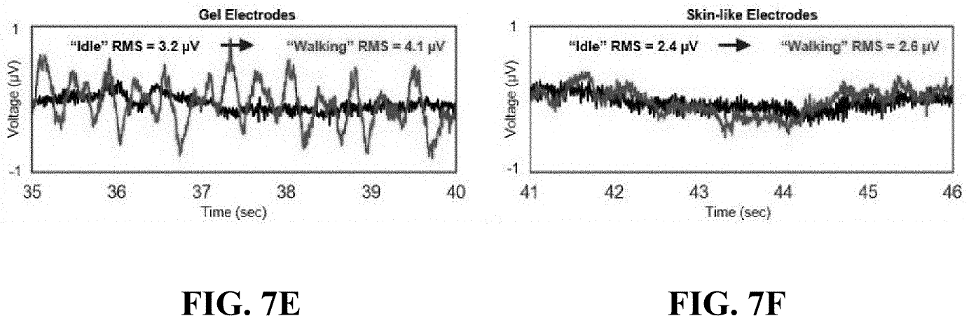

The details of the experimental setup and analysis results are shown in FIGS. 7A-7F. FIG. 7A shows electrode placement for the simultaneous comparison of the two types of electrodes. Each pair of electrodes is placed above and below each eye for detection of vertical eye movements along with respective ground electrodes. FIG. 7B is a photograph revealing the snug fitting of the nanomembrane electrodes (highlighted with dashed lines) whereas the gel electrodes and wires can be seen pressured by the VR headset, causing discomfort and incorrect fitting of the headset (arrows). FIG. 7C is a plot of average skin-like electrode impedance values of the electrodes. FIG. 7D is an SNR analysis of EOG from ten trials of the vertical eye movement protocol at the start and finish of the one hour session. The plots show raw EOG signals from one trial each from start and finish of the session. FIGS. 7E, 7F are RMS analyses of the EOG signals recorded while sitting down and walking on a treadmill at 3.2 mph. The subject stared at a fixed marker during the one minute session without blinking. The plots show the five second snapshots of the raw EOG signals during walking.

### Study of Ocular Vergence and Classification Accuracy Based on Sensor Positions

Recording of ocular vergence via EOG requires meticulous optimization to produce the maximum functionalities. A series of distances with eye vergence were assessed to establish a metric for classification. The most common distances that humans observe in daily life was the basis for the procedure in the physical and virtual domain.

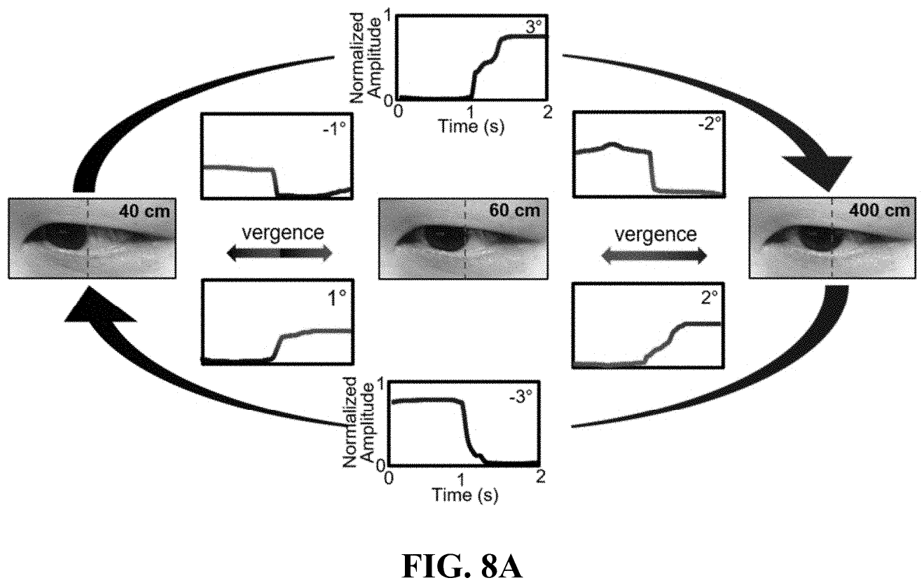

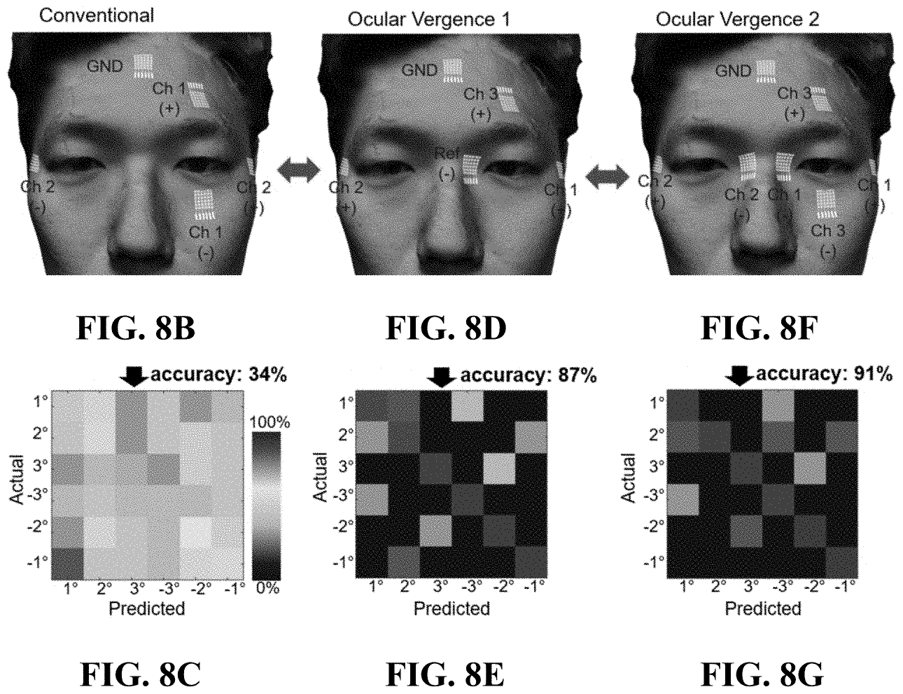

The discrepancy of the degrees of eye motion is a necessary physical attribute for eye vergence classification. FIGS. 8A-8G present a study of ocular vergence and classification accuracy based on sensor positions. FIG. 8A shows converging and diverging ocular motions and the corresponding EOG signals with three different targets, placed at 40 cm, 60 cm, and 400 cm away. FIGS. 8B, 8C show sensor positioning that resembles the conventional setting (two recording channels and one ground). FIGS. 8D, 8E show new positions for detecting ocular vergence, showing an enhanced accuracy 87%. FIGS. 8F, 8G show finalized sensor positions (ocular vergence 2) that include three channels and one ground, showing the highest accuracy of eye vergence.

FIG. 8A shows the individual converging and diverging ocular motions with the corresponding EOG signals. An example of diverging motions, from 80 cm to 60 cm and 800 cm, corresponds to positive potentials as the degree of eye vergence increases from 1° to 3° based of an interpupillary distance of 50 mm. Converging movements show an inverted potential in the negative direction, from 800 cm to 60 cm and 80 cm, corresponding from 3° to 1°. Conventional EOG sensor positioning aims to record synchronized eye motions with a large range of potentials in observing gaze tracking.

An experimental setup in FIG. 8B resembles the conventional setting (two recording channels and one ground on the forehead) for typical vertical and horizontal movements of eyes. A subject wearing the soft sensors was asked to look at three objects, located 80 cm, 60 cm, and 800 cm away. The measured classification accuracy of eye vergence signals shows only 38% (FIG. 8C) due to the combination of inconsistent potentials and opposing gaze motions. In order to preserve the signal quality of ocular vergence, three individual channels using a unipolar setup with a combined reference electrode positioned on the contour of the nose were used (ocular vergence 1; FIG. 8D), which results in the accuracy of 88% (FIG. 8E). Lastly, the accuracy of the present electrode positioning was assessed by adding two more electrodes (ocular vergence 2; FIG. 8F), which yielded 91% accuracy (FIG. 8G) with the least amount of deviation in the signals.

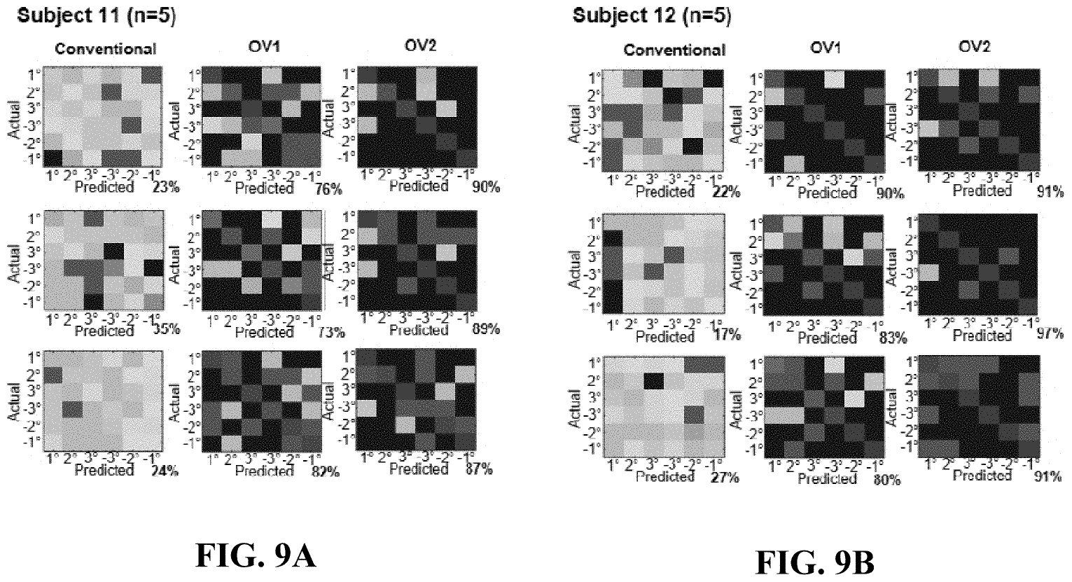

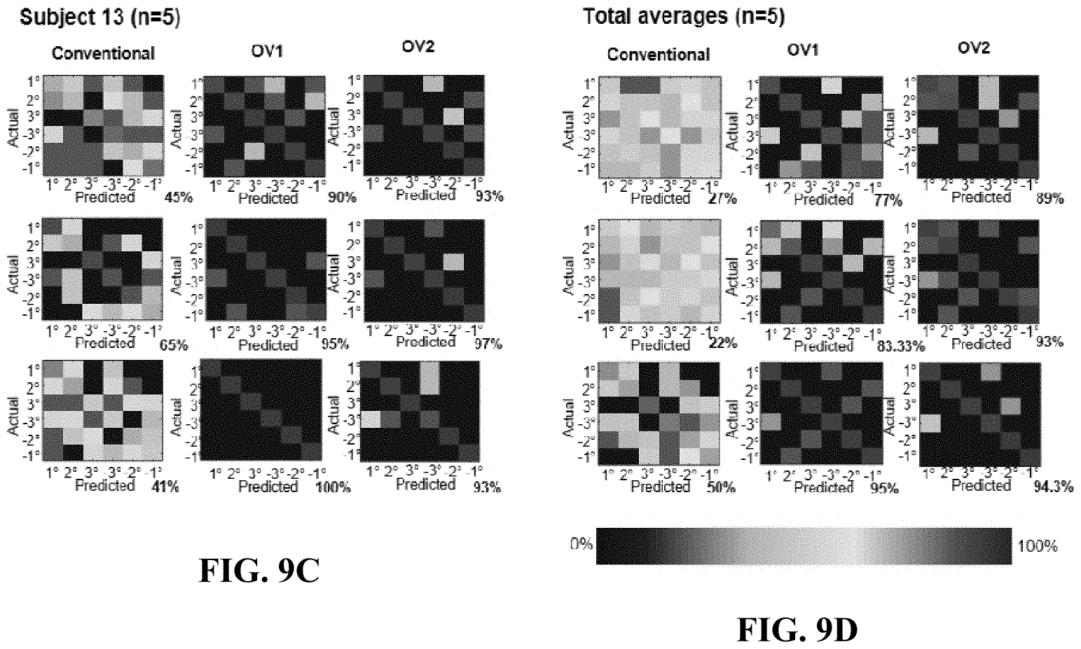

The classification accuracy per each sensor location is the averaged value from three human subjects (details of individual confusion matrices with associated accuracy calculation are summarized in FIGS. 9A-9D). FIGS. 9A-9D show the electrode assessment for subjects 11 to 13 using the virtual reality training platform.

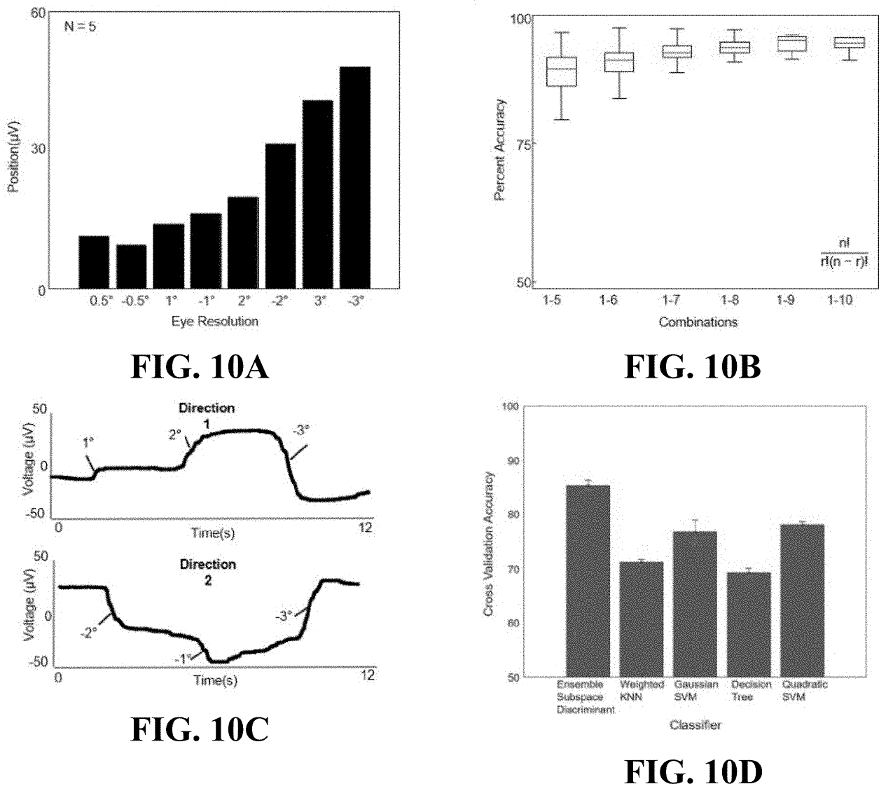

Additionally, the recording setup with the case of ocular vergence 2 (FIG. 8F) shows signal resolution as high as ˜26 μV/degree, which is significantly higher than our prior work ˜11 μV/degree. The lowest eye resolution we could achieve using the Brock string program yielded 0.5° eye vergence using the present invention (FIG. 10A). The increased sensitivity of vergence amplitude is due to the optimized positioning of the electrodes closer to the eyes, such as on the nose and the outer canthus. In addition, the portable, wireless wearable circuit has an increased gain of 12 in the internal amplifier.

FIGS. 10A-10D present the sensitivity of the periocular wearable electronics. FIG. 10A is a graph of the eye resolution of subject 12, which was observed to be as low as 15 μV for 0.5° of eye vergence in the VR headset. FIG. 10B is a graph showing the percent of accuracy with permutations of features from all three channels for position and velocity. FIG. 10C are graphs of the procedure for recording and training eye vergence involves following a linear procedure to extract all eye motions equal number of times. Direction 1 (top) and direction 2 (bottom) are repeated four times. FIG. 10D is a graph of the cross-validation accuracy of five-fold validation amongst five high ranking classifier accuracies from classification learner application. Subject 12 demonstrates highest average accuracy of 85% with standard deviation of 2%.

### Optimization of Vergence Analysis Via Signal Processing and Feature Extraction

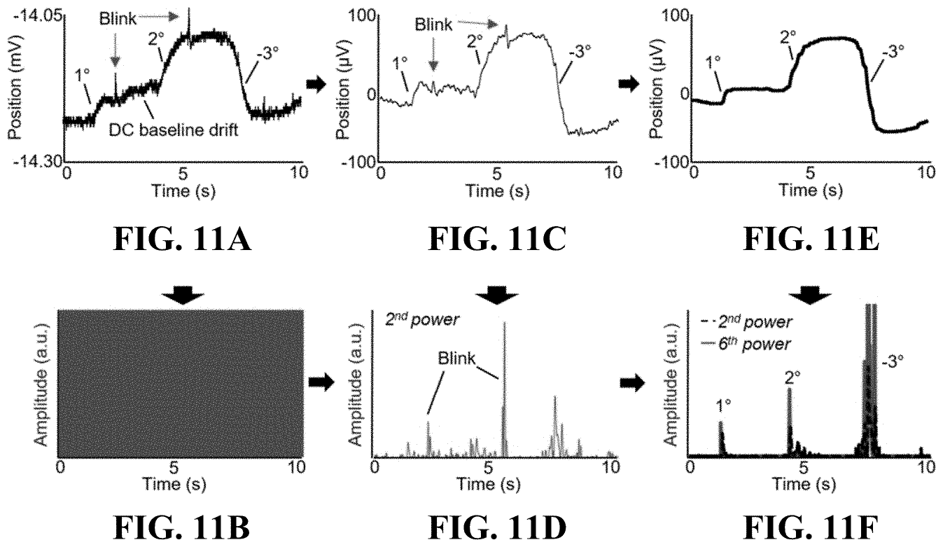

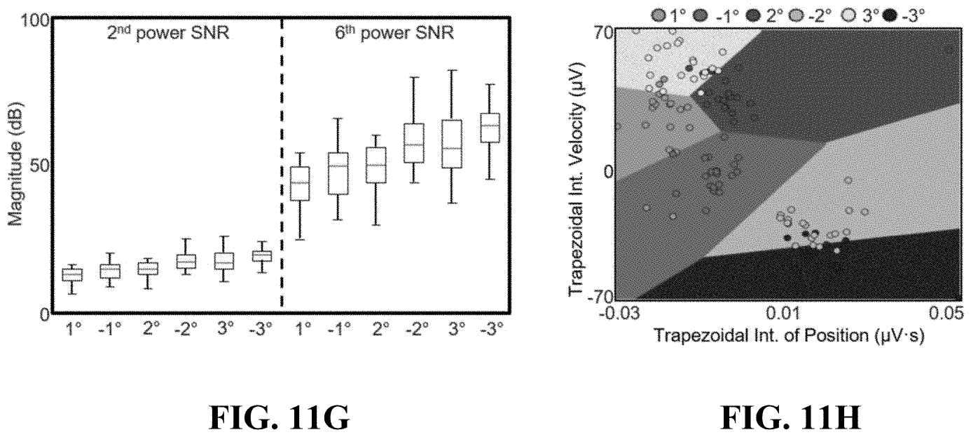

The variability of ocular vergence in both physical and VR domains were assessed to realize a fully portable vergence therapeutic program. FIGS. 11A, 11B are the raw eye vergence signals (FIG. 11A) acquired by the wireless ocular wearable electronics in real-time and the corresponding derivative signals (FIG. 11B). FIGS. 11C, 11D present the preprocessed data with a bandpass filter and the corresponding derivative, raised to the 2^{nd} power. FIGS. 11E, 11F present further processed data with a 500-point median filter and the corresponding derivative, raised to the 6^{th} power. A coefficient is multiplied to increase the amplitude of the 2^{nd} order and 6^{th} order differential filter. FIG. 11D is an SNR comparison between the 2^{nd} order and 6^{th} order differential filters, showing an increased range of the 6^{th} order data. The 6^{th} order data is used for thresholding the vergence signals for real-time classification of the dataset. FIG. 11D shows data from the sliding window is added into the ensemble subspace classifier, shown by the decision boundaries of two dimensions of the feature set.

As discussed, the acquired EOG signals from vergence motions require a mathematical translation using statistical analysis for quantitative signal comparison. Prior to algorithm implementation, raw EOG signals (FIG. 11A) from the ocular wearable electronics are converted to the derivative data (FIG. 11B). Due to the noise and baseline drift, a 3^{rd} order Butterworth bandpass filter is implemented from 0.1 Hz to 10 Hz.

The bandpass filter removes the drift and high frequency noise, so the derivative is much cleaner as shown in FIGS. 11C, 11D, according to the vergence motions. Data set shows that blink velocity is faster than vergence motions which corrupts thresholding. A 500-point median filter can remove any presence of the blink as shown in FIGS. 11E, 11F. However, stronger blinking from certain subjects remains and is removed by thresholding an amplified derivative signal.

Increasing the 2^{nd} order derivative filter to 6^{th} order can assist in positively altering the range of thresholds by changing the signal to noise ratio (FIG. 11G). The final step is to parse the data into a sliding window, compute features, and input it into the classifier. A decision boundary of two dimensions of the feature set with the ensemble classifier is shown in FIG. 11H. A wrapper feature selection algorithm was applied to determine if the utilization of ten features was optimized for the recorded EOG signals. In addition to five features (definite integral, amplitude, velocity, signal mean, and wavelet energy) from our prior study, we studied other features that can be easily converted into C programming using a MATLAB coder.

The result of the wrapper feature selection indicates a saturation of the accuracy with a mean accuracy of 95% (FIG. 10B). Therefore, all ten features were used in the classification methods with a sliding window of two seconds. In order to achieve the highest accuracies for real-time and cross-validation, the classification algorithm requires the test subject to follow protocols evoking a response of eye vergence in two directions. The test subject followed a repeated procedure from motion to blink, motion, and blink. This procedure allows the data to be segmented into its specific class for facile training with the classifier by following direction 1 and direction 2 four times each (FIG. 10C).

The integration of the training procedure with filters, thresholds, and the ensemble classifier enables the present high classification accuracies. Consequently, the presented set of high quality EOG measurement, integrated algorithm, and training procedures allow the calibration of vergence classification specific for the user, regardless of the variabilities in EOG arising from individual differences, such face size or shape. Multiple classifiers were tested in the MATLAB's classification learner application; however, the results show k nearest neighbor (KNN) and support vector machine (SVM) were inferior to ensemble subspace discriminant which showed accuracies above 85% for subject 12 (FIG. 10D).

### Methods for Cross-Validation

After the data is recorded it is stored into a .mat file for further processing. The data is stored in a double structure which is then separated in MATLAB cell arrays. The cell arrays are inserted into a Butterworth bandpass filter between, 0.01 Hz and 10 Hz. A zero-phase filter is implemented after data is recorded, while the real-time data is parsed in to 500 ms windows that are filtered after five seconds of data is recorded. The filtered data is separated into ten features that are inserted into the classifier for cross-validation. Numerous classifiers were compared in classification learner application prior to establishing the ensemble subspace discriminant as the best classifier by utilizing five-fold cross-validation with each classifier. MATLAB's cross-validation algorithm applies randomization of the training and testing data by splitting the data into five folds and six groups. Five out of the six groups are randomly indicated as training and the last group is randomly indicated as the testing group. The groups are divided into n groups equal to the number of classes. The output class is presented in a confusion matrix at the end of recording as well as real-time on the graphical user interface. This approach was utilized with all 14 test subjects with a minimum of at least three attempts from each subject towards training and testing.

### Comparison of Ocular Classification Accuracy Between VR and Physical Apparatus

This section summarizes the experimental results of ocular classification comparison between the soft ocular wearable electronics with a VR headset (FIG. 1A) and a conventional device with a physical target apparatus (FIG. 2A). Only the center position data among the circular targets (FIG. 1B) were analyzed and compared because this resembles the most accurate vergence motions without any noise from gaze motions. The physical apparatus was transferred to the virtual domain by converting flat display screen images to fit the human binocular vision.

The VR headset enabled the capture of ideal eye vergence motions because head motions are disabled, and the stimulus is perfectly aligned with the user's binocular vision. This is evident from the averaged signal and standard deviation of the normalized position of the ideal datasets shown in FIGS. 12A, 12B (middle line: average and shadow: deviation with different gain values (12 for VR and 1 for physical system).

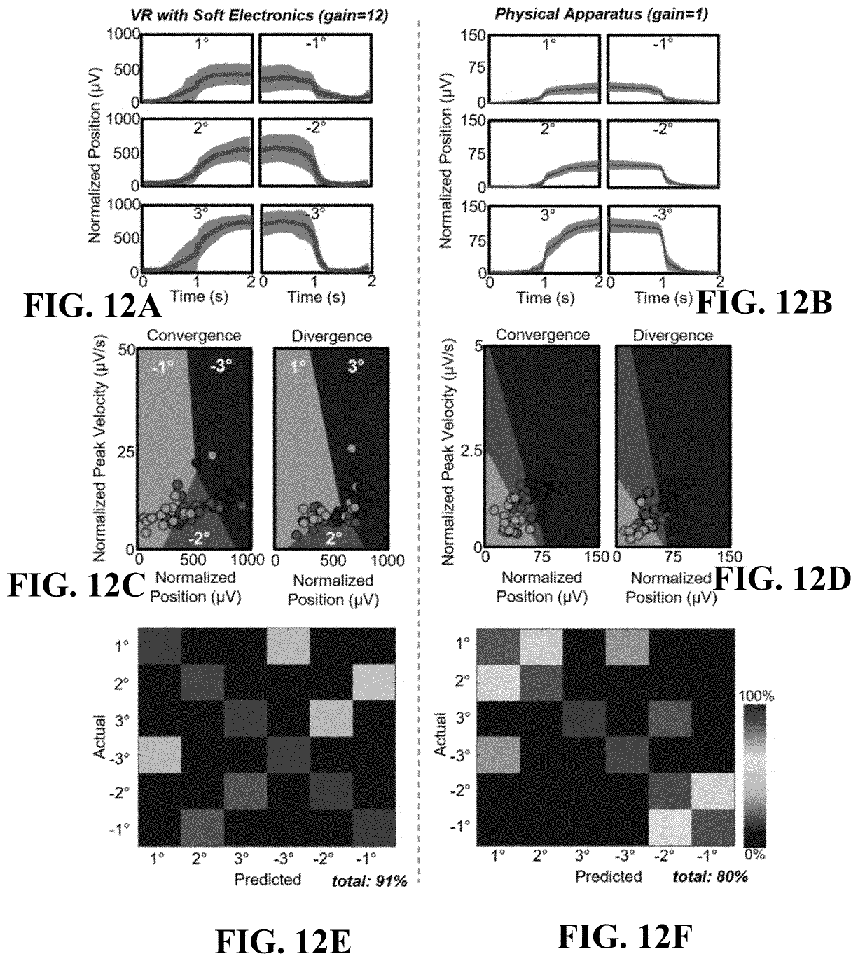

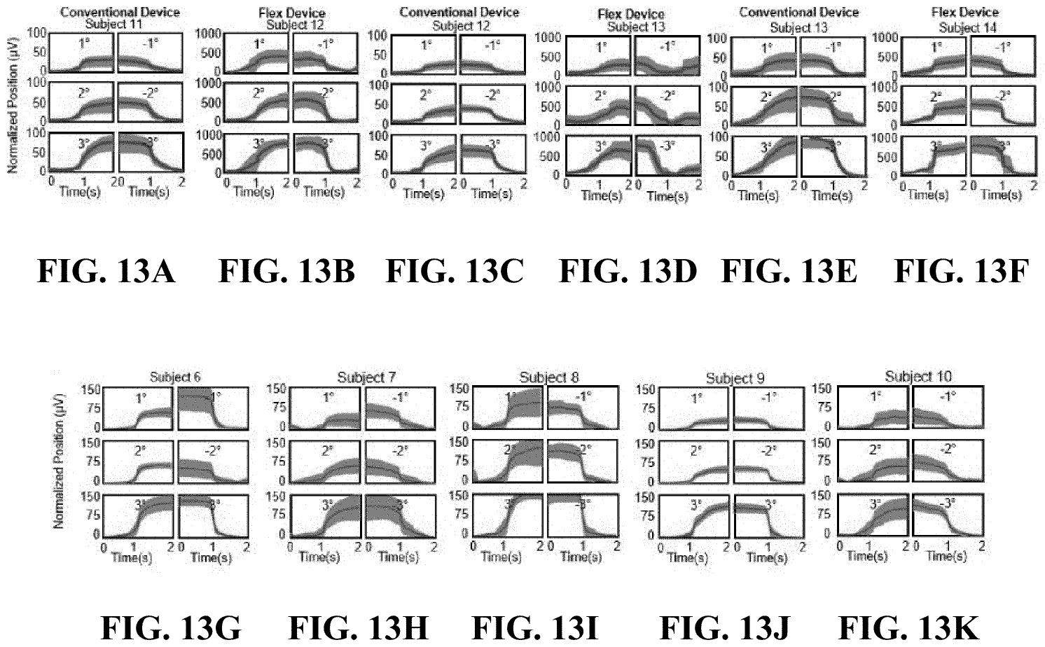

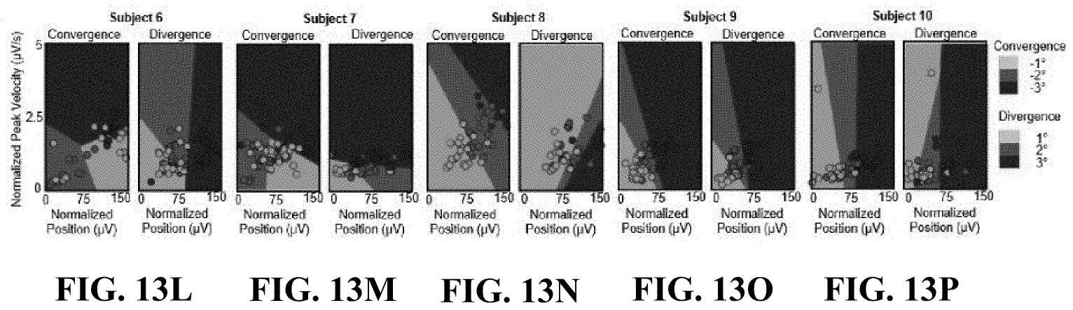

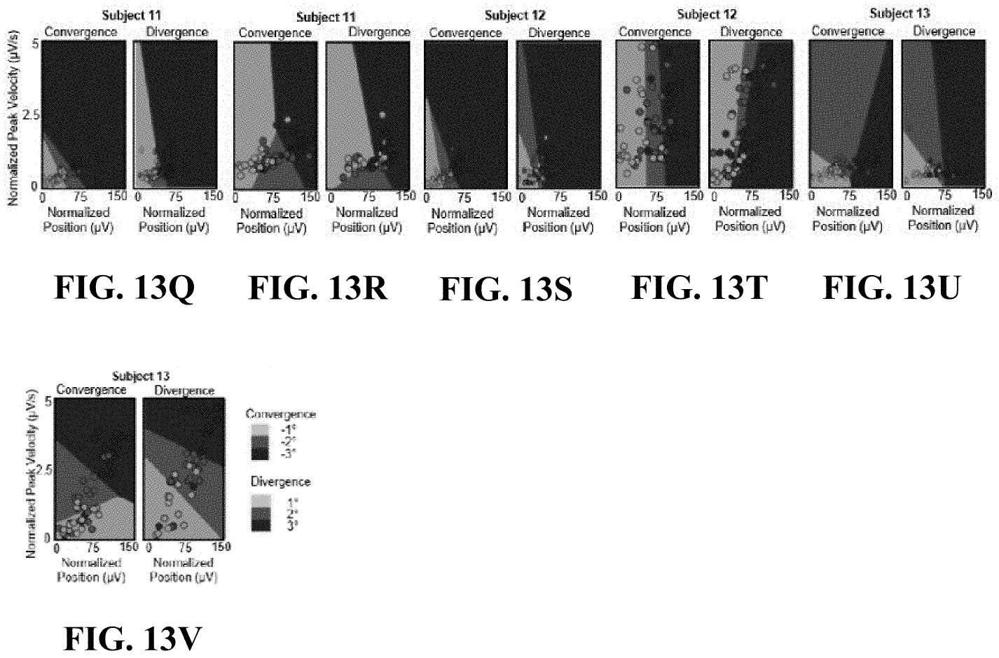

The physical apparatus data shows a larger variation in overall trials in comparison to the VR headset as observed in FIGS. 13A-13K. This is a consequence of the test apparatus with each user's variability in observation of the physical apparatus. The normalized peak velocities were also compared according to the normalized positions for both convergence and divergence in FIGS. 12C, 12D (an additional datasets are summarized in FIGS. 13L-13V).

FIGS. 12A-12F are a comparison of ocular classification accuracy between virtual reality and physical apparatus. FIGS. 12A, 12B are representative normalized data of eye vergence (line: average and shadow: deviation), recorded with a VR system (FIG. 12A) and a physical apparatus (FIG. 12B). VR device uses higher signal gain than the physical setup. FIGS. 12C, 12D are normalized peak velocities according to the normalized positions for both convergence and divergence in the VR (FIG. 12C) and physical setup (FIG. 12D). FIGS. 12E, 12F are a summarized comparison of averaged classification accuracy (total six human subjects) based on cross-validation with the VR-equipped soft ocular wearable electronics (91% accuracy) (FIG. 12E) and physical apparatus (80% accuracy) (FIG. 12F).

FIGS. 13A-13V illustrate performance differences between the periocular wearable electronics and the physical apparatus. FIGS. 13A-13F illustrate normalized eye vergence motions recorded with subjects 11-13 using the virtual apparatus. The normalized signals for each user for all vergence motions indicate more precise responses in the VR display. FIGS. 13G-13K are the normalized signals for each user from subjects 6-10 for all vergence motions indicate high variability with signal collection with physical apparatus. FIGS. 13L-13P are the normalized peak velocity vs position for subjects 6-10 in physical apparatus. The virtual reality data from subjects 11-13 from eye therapy training program with decision boundaries. FIGS. 13Q-13V show the virtual reality data from subjects 11-13 from eye therapy training program with decision boundaries using the VR apparatus.

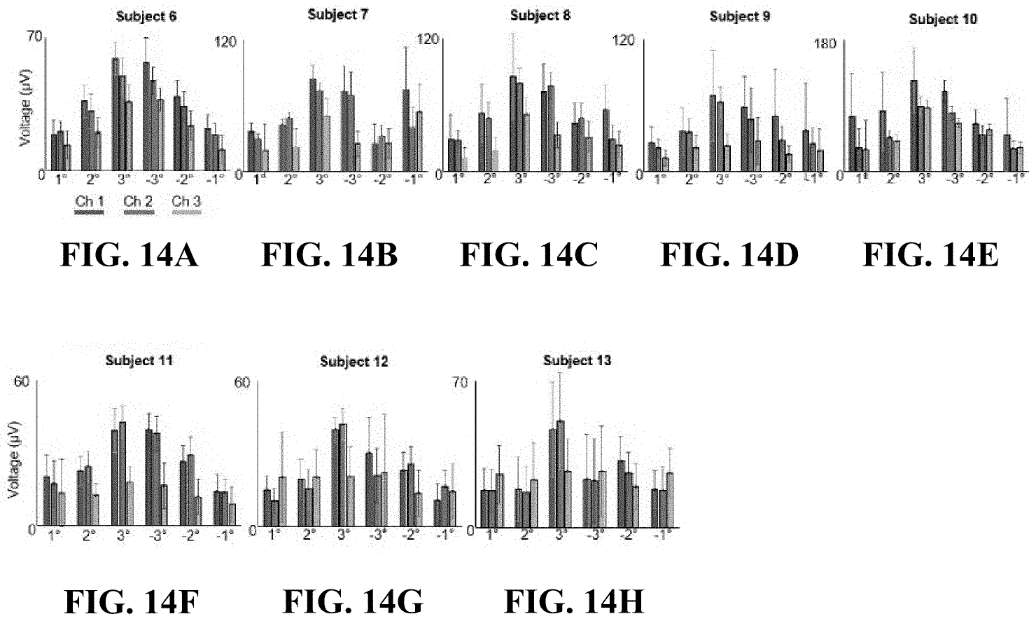

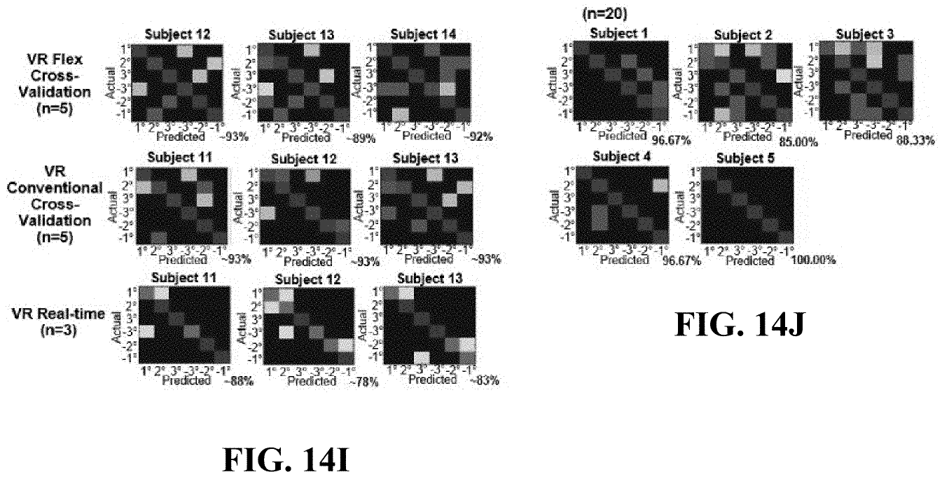

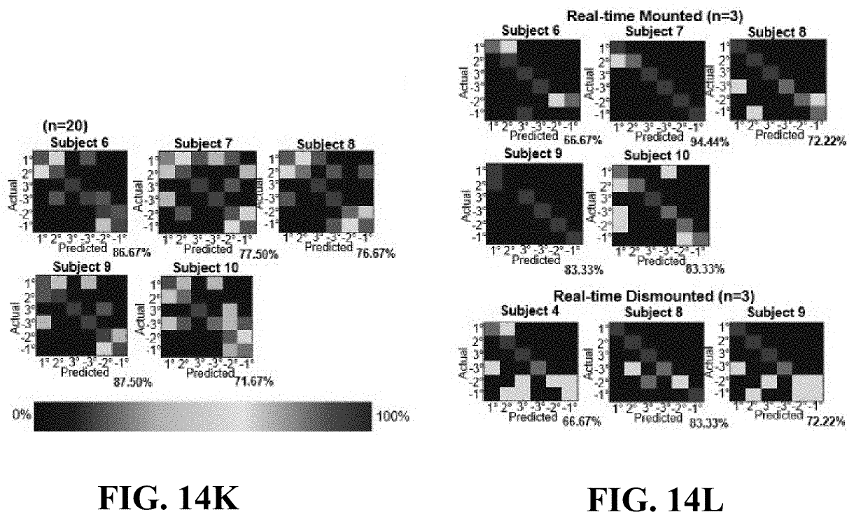

Utilizing a rise time algorithm, the amplitude changes and variation of all datasets from physical and VR are shown in FIGS. 14A-14H. The summarized comparison of classification accuracy based on cross-validation with the VR-equipped soft ocular wearable electronics show higher value (91%) than that with the physical apparatus (80%), as shown in FIGS. 12E, 12F.

The intrinsic quality of the ensemble classifier shows high variance in cross-validation assessments. Even with the real-time classification, the ensemble classifier yields about 83% and 80% for the VR environment and the physical apparatus, respectively. The VR real-time classification is higher than the physical apparatus due to less variation between opposing motions of positive and negative changes. Details of the classification accuracies in cross-validation and real-time are summarized in FIGS. 141-14L and TABLES 2-5.

TABLE 2 is a cross-validation accuracies of subjects 1 to 5 using the physical apparatus. Subjects 1-5 conducted eye vergence training with all nine positions; the corresponding accuracies are shown here.

TABLE 2

| | | All nine positions | | | | | | | | |
|---|---|---|---|---|---|---|---|---|---|---|
| | | Center | 0° | 45° | 90° | 135° | 180° | 215° | 270° | 315° |
| Percent of | S1 | 96.67 | 96.67 | 95.00 | 98.33 | 97.50 | 99.17 | 96.67 | 97.50 | 95.83 |
| Accuracy of | S2 | 85.00 | 82.50 | 85.83 | 83.33 | 88.33 | 90.83 | 93.33 | 89.17 | 89.17 |
| Each Subject | S3 | 88.33 | 91.67 | 95.00 | 94.17 | 95.00 | 93.33 | 91.67 | 92.50 | 88.33 |
| | S4 | 96.67 | 87.50 | 95.00 | 96.67 | 98.33 | 90.00 | 89.17 | 93.33 | 95.00 |
| | S5 | 100.00 | 90.83 | 95.83 | 91.67 | 95.83 | 95.00 | 100.00 | 95.00 | 93.33 |

N = 20

TABLE 3 is a cross-validation assessment of subjects 6 to 10 using the physical apparatus. Subjects 6-10 conducted eye vergence training with all nine positions; the corresponding accuracies are shown here.

TABLE 3

| | | All nine positions | | | | | | | | |
|---|---|---|---|---|---|---|---|---|---|---|
| | | Center | 0° | 45° | 90° | 135° | 180° | 215° | 270° | 315° |
| Percent of | S6 | 86.67 | 76.67 | 94.17 | 85.00 | 82.50 | 80.00 | 72.50 | 88.33 | 90.00 |
| Accuracy of | S7 | 77.50 | 90.00 | 98.33 | 90.83 | 96.67 | 96.67 | 99.17 | 99.17 | 100.00 |
| Each Subject | S8 | 76.67 | 91.67 | 93.33 | 87.50 | 98.33 | 98.33 | 94.17 | 94.17 | 95.00 |
| | S9 | 87.50 | 92.50 | 84.17 | 85.00 | 92.50 | 90.83 | 97.50 | 97.50 | 94.17 |
| | S10 | 71.67 | 61.67 | 65.00 | 72.50 | 60.00 | 82.50 | 85.83 | 75.83 | 80.00 |

N = 20

TABLE 4 is a real-time classification of test subjects 6 to 10 using the physical apparatus. Subjects 6-10 underwent eye vergence training with all nine positions with the ocular mount. Real-time classification algorithm results under mounted condition is presented.

TABLE 4

| | | All nine positions | | | | | | | | |
|---|---|---|---|---|---|---|---|---|---|---|
| | | Center | 0° | 45° | 90° | 135° | 180° | 215° | 270° | 315° |
| Percent of | S6 | 66.67 | 83.33 | 83.33 | 72.22 | 77.78 | 88.89 | 83.33 | 77.78 | 77.78 |
| Accuracy of | S7 | 94.44 | 88.89 | 100.00 | 94.44 | 88.89 | 88.89 | 88.89 | 100.00 | 100.00 |
| Each Subject | S8 | 83.33 | 88.89 | 88.89 | 94.44 | 94.44 | 94.44 | 94.44 | 88.89 | 100.00 |
| | S9 | 83.33 | 88.89 | 77.78 | 72.22 | 83.33 | 88.89 | 100.00 | 100.00 | 94.44 |
| | S10 | 72.22 | 72.22 | 66.67 | 72.22 | 77.78 | 88.89 | 88.89 | 100.00 | 66.67 |

N = 3

TABLE 5 is a real-time classification of test subjects 4, 8, and 9 using the physical apparatus. Subjects 4, 8 and 9 underwent eye vergence training with all nine positions without the ocular mount. Real-time classification algorithm results under dismounted condition is presented.

TABLE 5

| | | All nine positions | | | | | | | | |
|---|---|---|---|---|---|---|---|---|---|---|
| | | Center | 0° | 45° | 90° | 135° | 180° | 215° | 270° | 315° |
| Percent of | S4 | 66.67 | 66.67 | 83.33 | 83.33 | 88.89 | 88.89 | 88.89 | 94.44 | 94.44 |
| Accuracy of | S8 | 83.33 | 88.89 | 94.44 | 88.89 | 100.00 | 100.00 | 88.89 | 94.44 | 94.44 |
| Each Subject | S9 | 72.22 | 83.33 | 88.89 | 88.89 | 94.44 | 88.89 | 83.33 | 88.89 | 94.44 |

N = 3

### VR-Enabled Vergence Therapeutic System

As the gold standard method, conventional home-based vergence therapy utilizes pencil pushups in conjunction with office-based visual therapy. Adding a VR headset to home-based therapy with a portable data recording system can certainly make a patient use the same therapeutic program both at optometrist's office and home. To integrate with the developed ocular wearable electronics, we designed two ocular therapy programs in a Unity engine (unity3d.com).

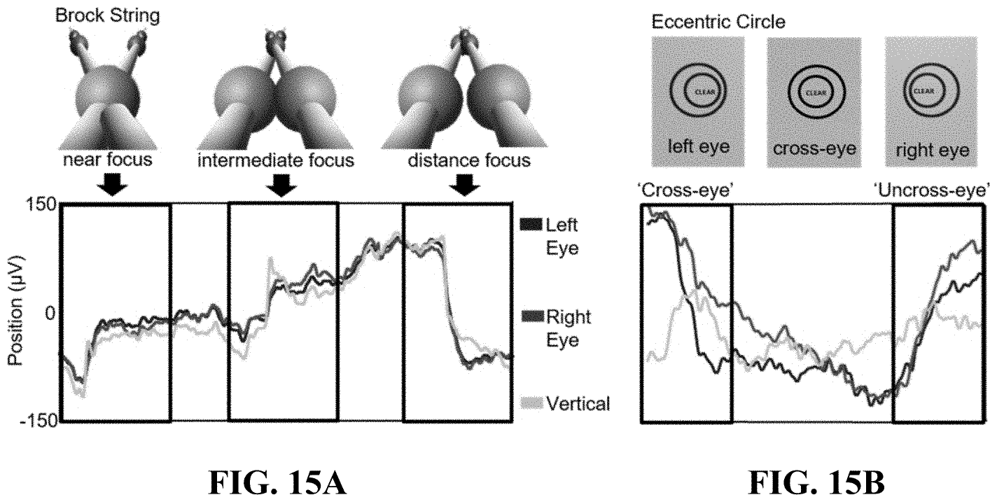

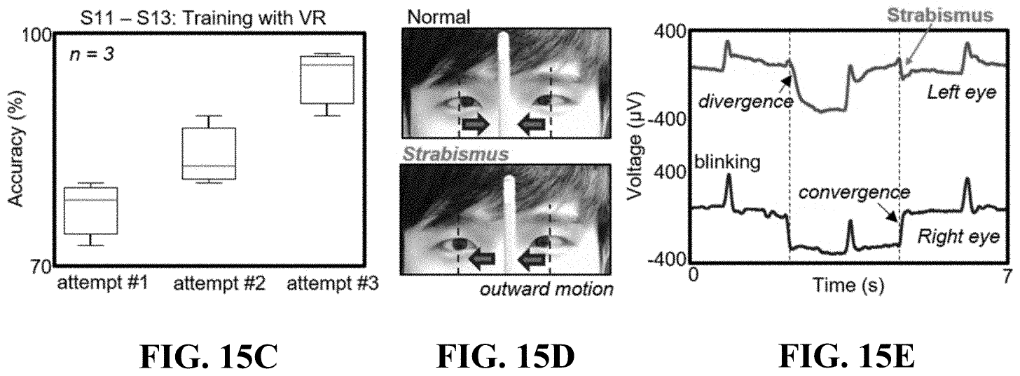

The first program enables a patient to use the virtual ‘Brock String’ (FIG. 15A) which is string of 100 cm in length with three beads, originally designed to treat patients with strabismus. The string is offset 2 cm below the eye and centered between the eyes with the three beads at varying distances. Three channels of soft sensors on the face (FIG. 8F) measure EOG signals, corresponding to a subject's eye movements targeting on three beads (FIG. 15A).

The second therapy program uses a set of two cards with concentric circles on each card referred to as ‘Eccentric Circle’ (FIG. 15B), which is also widely used program in vergence therapy. The corresponding EOG signals show the user, wearing the VR headset, cross his eyes to yield the center card. The distance between the left and right card can be increased to make this task more difficult. The signal also demonstrates the difficulty of the eye crossing motion due to the lower velocity. These programs can be used as an addition to the office therapy of the CI treatment procedures.

FIGS. 15A-15E illustrates the present VR-enabled vergence therapeutic system. FIG. 15A is an example of ocular therapy programs in the VR system: ‘Brock String’ which is string of 100 cm in length with three beads (top images) and measured eye vergence signals (bottom graph). FIG. 15B illustrates a program, named ‘Eccentric Circle’ that uses a set of two cards with concentric circles on each card (top images) and corresponding EOG signals (bottom). FIG. 15C evidences continuous use of the VR headset program, showing improved eye vergence, acquired from three human subjects with no strabismus issues from near point convergence. FIG. 15D are photos of strabismus exotropia, showing a subject who had difficulty holding the near point convergence during pencil pushups. FIG. 15E shows the corresponding EOG signals upon convergence and divergence during the pencil pushups; left eye shows slower response at convergence, followed by an exotropic incidence after the blink at the near position.

As noted, continuous use of the VR headset program (FIG. 15C) presents improved eye vergence, acquired from three human subjects with no strabismus issues from near point convergence. Users indicate the difficulty of converging in earlier tests (accuracy: ˜75%), which improves over time (final accuracy: ˜90%). In addition, we found a subject who had difficulty holding the near point convergence motions in the VR headset which was determined to be strabismus exotropia (FIG. 15D). This subject was also asked to perform pencil pushups from 3 cm up to 60 cm in the physical domain (FIG. 15D). The corresponding EOG signals upon convergence and divergence during the pencil pushups appear in FIG. 15E. While the right eye signals (lower line) show the correct divergence and convergence positions, his left eye shows slower response at convergence, followed by an exotropic incidence after the blink at the near position. Typically, a blink results in high velocity increase and decrease of potentials, but in this case the potential does not decrease after the blink moment. A divergence motion should increase the EOG potential (as the right eye), but the signal drops 100 μV, meaning that the left eye moved outwards.

### DISCUSSION

Collectively, the development of a fully portable, all-in-one, periocular wearable electronic system with a wireless, real-time classification of eye vergence is introduced. The comprehensive study of soft and nanomaterials, stretchable mechanics, and processing optimization and characterization for aerosol jet printed EOG electrodes enabled the first demonstration of highly stretchable and low-profile biopotential electrodes that allowed a comfortable, seamless integration with a therapeutic VR environment. Highly sensitive eye vergence detection was achieved by the combination of the skin-like printed EOG electrodes, optimized sensor placement, and novel signal processing and feature extraction strategy. When combined with a therapeutic program-embedded VR system, the users were able to successfully improve the visual training accuracy in an ordinary office setting. Through the in vivo demonstration, we showed that the soft periocular wearable electronics can accurately provide quantitative feedback of vergence motions, which is directly applicable to many CI and strabismus patients. Overall, the VR-integrated wearable system verified its potential to replace archaic home therapy protocols such as the pencil pushups.

While the present invention focuses on the development of the integrated wearable system and demonstration of its effectiveness on vergence monitoring with healthy population, additional work investigates the use of the wearable system for home-based and long-term therapeutic effects with eye disorder patients. The quantitative detection of eye vergence can also be utilized for diagnosis of neurodegenerative diseases and childhood learning disorders, both of which are topics of high impact research studies that are bottlenecked by the lack of low-cost and easy-to-use methods for field experiments. For example, Parkinson's patients exhibit diplopia and convergence insufficiency while rarer diseases such as spinocerebellar ataxia type 3 and type 6 can demonstrate divergence insufficiency and diplopia as well. Although these diseases are not yet fully treatable, quality of life can be improved if the ocular conditions are treated with therapy. Beyond disease diagnosis and treatment domains, the presented periocular system may serve as a unique and timely research tool in the prevention and maintenance of ocular health, a research topic with increasing interests due to the excessive use of smart devices.

### Materials and Methods

Fabrication of a Soft, Flexible Electronic Circuit

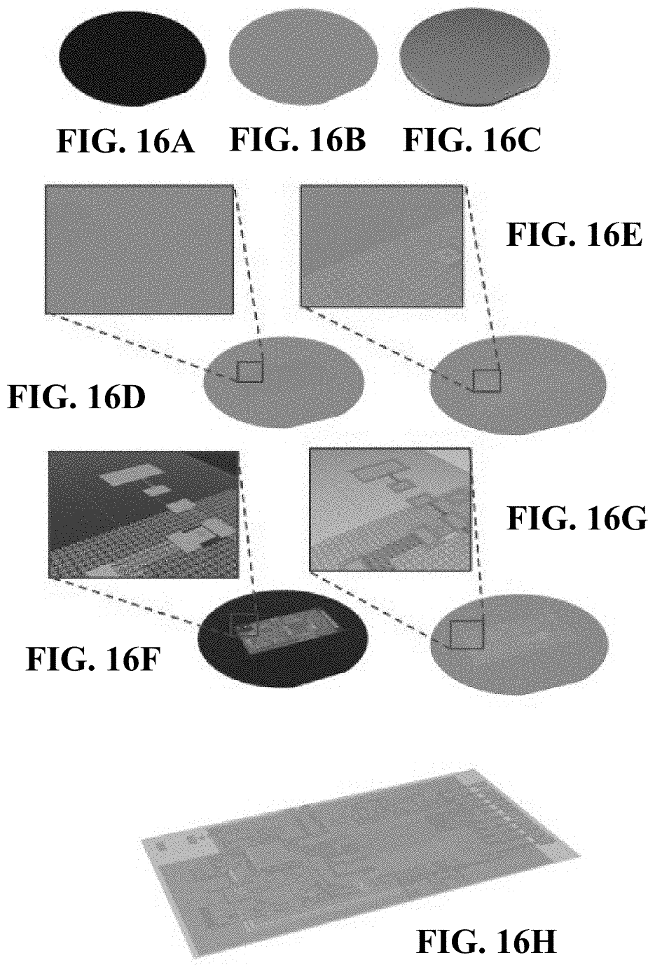

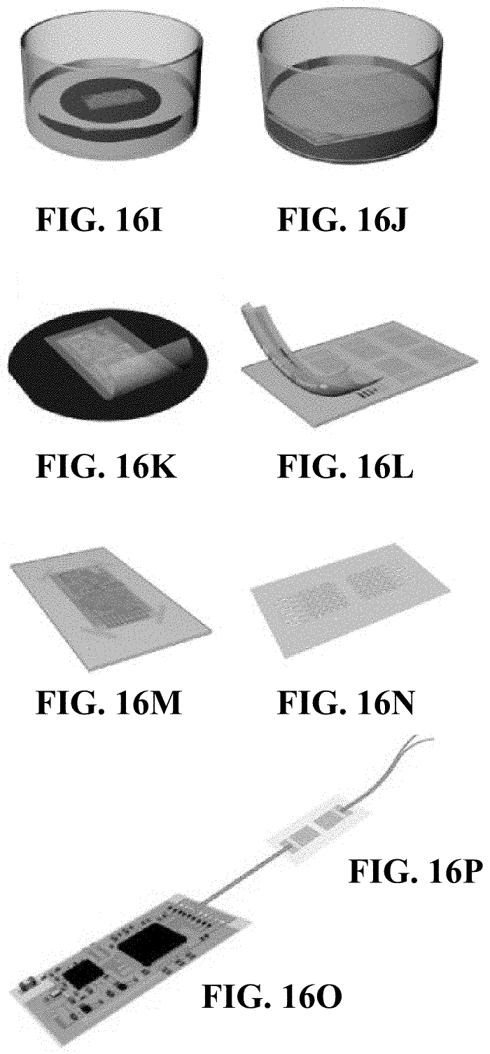

The portable and wearable flexible electronic circuit was fabricated to integrate a set of skin-like electrodes for wireless detection of eye vergence. The combination of newly developed transfer printing and hard-soft integration with a conventional microfabrication technique allowed for successful manufacture of the flexible electronics (details of the device fabrication follow and are shown in FIGS. 16A-16P). The ocular wearable electronic system includes multiple units: a set of skin-like sensors, signal filtering/amplification, Bluetooth-low-energy wireless telemetry, and antenna.

FIGS. 16A-16P illustrate the fabrication and assembly processes for the flexible device and the skin-like electrodes. FIG. 16A is a flexible device fabrication is conducted using a clean silicon wafer on which to build (FIG. 16B) a layer of PMMA and PI. Sputter copper (FIG. 16C) and then (FIG. 16D) etch the copper with APS-100. Spin cast two layers of PI (FIG. 16E) and etch the holes. Deposit copper to fill in holes (FIG. 16F) and create top interconnect layer. Spin cast PI (FIG. 16G) and etch away the top layer. Finished design (FIG. 16H) is ready to transfer after removing any copper oxides using stainless steel flux. Flexible device is submerged (FIG. 16I) in a bath of acetone at 60° C. overnight (FIG. 16J) while the skin-like electrode is processed in the acetone bath for one hour. Use the water-soluble tape (FIG. 16K) to transfer the device off the silicon wafer and (FIG. 16L) skin-like electrode off the glass slide. Prepare the Ecoflex gel and Ecoflex 30 mixture (FIG. 16G) for the device and transfer simultaneously prepare the (FIG. 16N) Ecoflex gel sample on PVA for the skin-like electrodes. Solder the IC chips onto the thin film flexible board (FIG. 16O) and (FIG. 16P) attach ACF wires to the skin-like electrodes then configure the device and the skin-like electrodes together.

Fabrication process of flexible devices including conventional microfabrication techniques, double transfer printing process, direct writing on soft material with additive manufacturing, and chip mounting are presented below.
a) Preparation of A Carrier Wafer
   1. Clean a silicon wafer with acetone, IPA, and DI water.
   2. Dehydrate on a hot plate at 110° C. for three min.
   3. Apply O₂ plasma at 50 W for 60 sec.
   4. Spincoat PMMA A7 at 4000 rpm for 30 sec.
   5. Bake on a hot plate at 180° C. for two min 30 sec.
   6. Spincoat PI (PI) at 4000 rpm for one min.
   7. Pre-bake on a hot plate at 150° C. for five min.
   8. Hard bake on a hot plate at 250° C. for 55 min.
b) Material Deposition And Photolithography
   1. Deposit 1 μm-thick copper (Cu) using sputtering systems.
   2. Spincoat photoresist (AZ 4620) at 2000 rpm for 30 sec.
   3. Bake on a hot plate at 110° C. for five min.
   4. Align with a photomask and expose UV light, exposure dose of 320 mJ/cm².
   5. Develop patterns with a developer (AZ 400K, 1:3 dilution).
   6. Etch Cu using copper etchant.
   7. Remove photoresist using acetone.
   8. Dehydrate on a hot plate at 110° C. for three min.
   9. Apply O₂ plasma at 50 W for 30 sec.
   10. Spincoat PI at 900 rpm for one min.
   11. Bake on a hot plate at 150° C. for five min and 200° C. for 15 min.
   12. Spincoat second PI at 900 rpm for one min.
   13. Bake on a hot plate at 150° C. for five min and 200° C. for 45 min.
   14. Apply O₂ plasma at 50 W for 30 sec.
   15. Spincoat photoresist (AZ 4620) at 2000 rpm for 30 sec.
   16. Bake on a hot plate at 110° C. for five min.
   17. Align with a photomask and expose UV light, exposure dose of 320 mJ/cm².
   18. Develop patterns with a developer (AZ 400K, 1:3 dilution).
   19. Etch PI using reactive ion etcher (RIE) at 150 W, 150 mTorr, and 20 SCCM O₂ for 18 min.
   20. Remove photoresist using acetone.
   21. Dehydrate on a hot plate at 110° C. for three min.
   22. Apply O₂ plasma at 50 W for 30 sec.
   23. Deposit 2 μm-thick Cu using sputtering systems.
   24. Spincoat photoresist (AZ 4620) at 2000 rpm for 30 sec.
   25. Bake on a hot plate at 110° C. for five min.
   26. Align with a photomask and expose UV light, exposure dose of 320 mJ/cm².
   27. Develop patterns with a developer (AZ 400K, 1:3 dilution).
   28. Etch Cu using copper etchant.
   29. Remove photoresist using acetone.
   30. Dehydrate on a hot plate at 110° C. for three min.
   31. Apply O₂ plasma at 50 W for 30 sec.
   32. Spincoat PI at 4000 rpm for one min.
   33. Bake on a hot plate at 150° C. for five min and 200° C. for 45 min.
   34. Apply O₂ plasma at 50 W for 30 sec.
   35. Spincoat photoresist (AZ 4620) at 2000 rpm for 30 sec.
   36. Bake on a hot plate at 110° C. for five min.
   37. Align with a photomask and expose UV light, exposure dose of 320 mJ/cm².
   38. Develop patterns with a developer (AZ 400K, 1:3 dilution).
   39. Etch PI using reactive ion etcher (RIE) at 150 W, 150 mTorr, and 20 SCCM O₂ for 30 min.
   40. Remove photoresist using acetone.
c) Preparation Of A Thin Elastomeric Membrane
   1. Prepare 4 g of 1:1 Ecoflex00-30 and 6 g of 1:1 Ecoflex Gel and mix them together.
   2. Spincoat the mixture at 200 rpm for 30 sec on five inch plastic petri dish.
   3. Cure at room temperature.
d) Pick Up And Transfer Printing Of Intraoral Electronic Device
   1. Immerse fabricated intraoral electronic circuit on wafer in acetone overnight.
   2. Pick up the intraoral electronic circuit using water-soluble tape.
   3. Transfer onto thin elastomeric membrane.
   4. Dissolve the water-soluble tape by gently applying water.
e) Mount Electronic Chips
   1. Screen print low temperature solder paste (alloy of Sn/Bi/Ag (42%/57.6%/0.4%), Chip Quik Inc.) with alignment on the intraoral electronic circuit.
   2. After mounting all necessary chips on proper contact pads, apply heat according to recommended reflow profile.
   3. Apply soldering Flux if necessary.
   4. Attach a 1×1×1 mm³ neodynium magnet to sensor pads for complete circuit.
f) Fabrication Of Skin-Like Electrode With Aerosol Jet Printing
   1. Prepare a glass slide by cleaning with acetone and IPA.
   2. Spin coat PMMA A7 thickness of 700 nm at 4000 RPM for 30 seconds.
   3. Bake the PMMA for two min 30 sec.
   4. Spin coat a layer of PI 2545, thickness of 1 μm at 5000 RPM for one minute.
   5. Bake the PI-2545 for 60 minutes at 250° C. on a hotplate.
   6. Surface treat the sample with air plasma for 30 seconds.
   7. Load sample on aerosol jet print (AJP) platen and set temperature to 70° C.
   8. Turn on the sheath flow rate at 30 SCCM.
   9. Turn on the atomizer flow rate at 20 SCCM.
   10. Turn on the atomizer current at 0.6 Amps.
   11. Deposit silver by running the program.
   12. Sinter the nanoparticles at 200° C. for one hour.
   13. Load sample on AJP platen and set temperature to 70° C.
   14. Turn on the sheath flow rate at 30 SCCM.
   15. Turn on the atomizer flow rate at 20 SCCM.
   16. Turn on the atomizer current at 0.6 Amps.
   17. Align silver layer with next layer using fiducial markers.
   18. Deposit diluted SC1813 by running the program.
   19. Bake for five minutes at 110° C.
   20. Etch PI using reactive ion etcher (RIE) at 250 W, 150 mTorr, and 20 SCCM O₂ for 20 min.
   21. Remove photoresist with acetone.
g) Pick Up And Transfer Printing Of AJP Skin-Like Electrode
   1. Clean a glass slide with acetone and IPA and dehydrate at 100° C.
   2. Laminate a film of polyvinyl alcohol (PVA) onto the glass slide with scotch tape.
   3. Prepare 2.5 g of Ecoflex gel mixture 1:1 and spin coat it at 2000 RPM for one min.
   4. Let Ecoflex gel cure at room temperature for two hours.
   5. Take the skin-like electrode sample and place into a bath of acetone.
   6. Heat up the acetone bath at 60° C. for one hour.
   7. Transfer the sample with a PVA-based water-soluble tape.
   8. Place the transferred samples and the tape onto the Ecoflex gel substrate.
   9. Hydrate the tape to dissolve.
   10. Attach anisotropic conductive film (ACF) wires to the skin-like electrode on the pad side.
   11. Attach a 1×1×1 mm³ magnet to the wire with silver paint.

Fabrication of Soft, Skin-Like, Stretchable Electrodes

An AJP method was used to design and manufacture the skin-like electrodes (details of this method are recited above and are shown in FIG. 16I). The additive manufacturing method patterned AgNPs on glass slides spin-coated with poly(methyl methacrylate) (PMMA) and PI. A reactive ion etching was followed to remove the exposed polymers to create stretchable mesh patterns. A flux was used to remove an oxidized layer on the patterned electrode. The last step was to dissolve the PMMA in acetone and transfer onto an elastomeric membrane, facilitated by a water-soluble tape (ASWT-2, Aquasol).

In Vivo Experiment With Human Subjects

The eye vergence study involved 14 volunteers ages 18 to 40 and the study was conducted by following the approved IRB protocol (#H17212) at Georgia Institute of Technology. Prior to the in vivo study, all subjects agreed with the study procedures and provided signed consent forms.

Vergence Physical Apparatus

An aluminum frame-based system was built to accustom a human subject with natural eye vergence motions in the physical domain (FIGS. 2A-2C). An ⅛″ thick glass was held erect by a thin three-foot threaded nylon rod screwed into a rail car. The rail car could be moved to any position, horizontally, along the five-foot aluminum bar at a height of five foot. A human subject was asked to place the head on an optometric mount for stability during the vergence test. Furthermore, a common activity recognition setup was placed a table consisting of a smartphone, monitor and television. The user was required to observe the same imagery on the screen at three different locations.

Thus, after device and sensor fabrication, it is ready to be used on a test subject for testing with physical apparatus or virtual reality apparatus.
a) Physical Apparatus
   1. Place electrodes in desired position, conventional, OV1, or OV2.
   2. Place device on shirt if using conventional radio or place flexible device on back of the neck.
   3. Setup physical apparatus in a room with 500×500 cm of space.
   4. Assist the participant by placing their head on the ocular headstand for stability during testing.
   5. Instruct the participant to follow the commands from the MATLAB program.
   6. After 70 seconds, record the data by selecting each trial and position on the apparatus individually.
   7. After five trials are recorded, press the cross-validation button to assess your dataset.
b) Virtual Apparatus
   1. Place electrodes in desired position, conventional, OV1, or OV2.
   2. Place device on shirt if using conventional radio or place flexible device on back of the neck.
   3. Initiate the correct application on the Samsung S6 and then place the Samsung S6 in gear VR.
   4. Assist the participant by placing the Samsung S6 and Samsung gear VR on the head.
   5. After tightening straps, instruct the user to initiate the program at the same time as the MATLAB program.
   6. After 70 seconds, record the data by selecting each trial and position on the apparatus individually.
   7. After five trials are recorded, press the cross-validation button to assess your dataset.

VR Vergence Training Program

A portable VR headset running on a smartphone (Samsung Gear VR) was used for all training and therapy programs (above). Unity engine made development of VR applications simpler by accurately positioning items that mock human binocular vision. We simulated our eye vergence physical apparatus on the VR display and optimized head motions by disabling the feature for idealistic geometric positioning. A training procedure was evoked with audio feedback from the MATLAB application.

VR Vergence Therapy Program

The eye therapy programs were chosen based off eye vergence and accommodation therapy guidelines from the literature. Two types of home-based visual therapy techniques were reproduced, including Phase One—Brock String, and Phase Two—Eccentric Circles. Brock String involved three dots, at variable distances to simulate near, intermediate, and distance positions. Each individual dot can be moved for the near (20 cm to 40 cm), intermediate (50 to 70 cm), and distance (80 to 100 cm) positions. Eccentric Circles allowed the user to move the cards laterally outwards and inwards to make cross-eye motions difficult. This motion was controlled by the touchpad and buttons on the Samsung Gear VR.

Classification Feature Selection

The first feature (Equation 15) shows cumulative trapezoidal method in which the filtered signal f (t) is summed upon each unit step, i to i+1, using the trapezoidal method for quick computation. The next feature (Equation 16) is the variance of the filtered signal. A root mean square is utilized (Equation 17), in conjunction with peak to root mean square ratio (Equation 18). The final feature is a ratio of the maximum over the minimum of the filtered window (Equation 19).

$$Ctrapz = {\sum }_{i = 1}^{1000} {\int }_{i}^{i + 1} fi ( t ) dt \qquad ( 15 )$$

$$V = \frac{1}{1000 - 1} {\sum }_{i = 1}^{1000} {\int }_{i}^{i + 1} \vert f ( t ) - μ \vert 2 \qquad ( 16 )$$

$$RMS = \sqrt{\frac{1}{1000}} {\sum }_{i = 1}^{1000} \vert {f}_{i} ( t ) \vert 2 \qquad ( 17 )$$

$$Peak 2 RMS = \frac{\vert max ( f ( t ) ) \vert}{RMS} \qquad ( 18 )$$

$$Peak 2 Peak = \frac{\vert max ( f ( t ) ) \vert}{\vert min ( f ( t ) ) \vert} \qquad ( 19 )$$

The rationalization of the use of the ensemble classifier is supported by the MATLAB's classification learner application. This application assesses numerous classifiers by applying k-fold cross-validation using the aforementioned features and additional sixty features. The datasets from our in vivo test subjects indicated a couple classifiers, quadratic support vector machine and ensemble subspace discriminant were consistently more accurate than others. The latter is consistently higher in accuracy with various test subjects in cross-validation assessments. The ensemble classifier utilizes a random subspace with discriminant classification rather than nearest neighbor. Unlike the other ensemble classifiers, random subspace does not use decision trees. The discriminant classification combines the best of the feature set and discriminant classifiers while removing the weak decision trees to yield its high accuracy. A custom feature selection script with the ideas of wrapper and embedded methods was conducted by incorporating the ensemble classifier.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. A portable system comprising:
a wearable ocular device configured to be worn by a wearer; and
skin-conformal electronics.

2. The system of claim 1, wherein the skin-conformal electronics comprise at least one skin-like electrode that is configured to make conformal proximal contact with the nose of the wearer.

3. The system of claim 2, wherein the skin-conformal electronics further comprise at least one flexible electronic circuit that is configured to make conformal proximal contact with the back of the neck of the wearer.

4. The system of claim 2, wherein each skin-like electrode comprises a stretchable aerosol jet printed electrode.

5. The system of claim 1 further comprising a processing system for running a therapy environment that simulates continuous movements of multiple objects in three varying depths of near, intermediate, and distance via the wearable ocular device.

6. The system of claim 5, wherein the three varying depths correspond to 1°, 2°, and 3° of eye motions.

7. The system of claim 5 further comprising an audio system configured to guide the wearer through the therapy environment.

8. A portable system comprising:
a wearable ocular device comprising a virtual reality (VR) headset configured to be worn by a wearer;
skin-conformal electronics comprising:
a first skin-like stretchable aerosol jet printed biopotential electrode configured for:
fit under the VR headset; and
high-fidelity detection of slight eye movements via conformal lamination on contoured areas around the eyes and nasal region of the wearer; and
a second wireless circuit configured for lamination on the back of the neck of the wearer; and
a processing system configured to provide accurate, real-time detection and classification of multi-degree eye vergence in a VR environment toward portable therapeutics of eye disorders.

9. The system of claim 8, wherein the portable system is an electrooculography (EOG)-based detection system of eye vergence with at least a 90% classification accuracy of multi-degree motions of eyes of the wearer.

10. The system of claim 9, wherein the processing system includes a mobile application configured to present a visual therapy program for eye convergence and divergence motions.

11. The system of claim 10, wherein the processing system further includes a MATLAB program configured to train and validate precise eye vergence motions for classification.

12. The system of claim 11, wherein the classification comprises an ensemble classifier based off subspace discriminant methods.

13. The system of claim 11, wherein the classification comprises a random forest classification algorithm that yields the at least a 90% classification accuracy.
